(19) United States
(12) Patent Application Publication
(10) Pub. No.: US 2025/0154806 A1
(43) Pub. Date: May 15, 2025

(54) WINDOW OPENING CONTROL DEVICE AND METHOD OF OPERATING THE SAME

(71) Applicant: GESCAR INDUSTRIEL INC., Saint-Lambert-de-Lauzon (CA)

(72) Inventors: Christian CARRIER, Saint-Lambert-de-Lauzon (CA); Sylvain Lacasse, Saint-Lambert-de-Lauzon (CA); Jocelyn Carrier, Saint-Lambert-de-Lauzon (CA); David Laliberte, Saint-Lambert-de-Lauzon (CA); David Gagnon, Saint-Lambert-de-Lauzon (CA); Luc Petitpas, Saint-Lambert-de-Lauzon (CA)

(21) Appl. No.: 18/944,942

(22) Filed: Nov. 12, 2024

Related U.S. Application Data
(60) Provisional application No. 63/598,274, filed on Nov. 13, 2023.

(51) Int. Cl. E05C 17/32

(52) U.S. Cl. CPC E05C 17/32

(57) ABSTRACT

A window opening control device having first and second restrictor arms, each one being pivotally securable to a respective one of a window frame and a window sash and having a connector. The connector of the first restrictor arm being couplable with the connector of the second restrictor arm in a pivotable connector connexion. The first and second restrictor arms are configurable in a compacted configuration in which they are superposed to one another, and an extended configuration in which their connectors are coupled together to limit a pivotal travel of the window sash with respect to the window frame. The opening control device further includes a release mechanism actionable to disengage the first and the second connectors. In a closed configuration of the window sash with respect to the window frame, the first and second restrictor arms are configured in the compacted configuration and are automatically coupled together.

### RELATED APPLICATION

This application claims priority to U.S. Provisional Patent Application Ser. No. 63/598,274, filed Nov. 13, 2023, entitled WINDOW OPENING CONTROL DEVICE AND METHOD OF OPERATING THE SAME, the contents of which are incorporated herein by reference.

### TECHNICAL FIELD

The technical field relates to window opening control devices, and more particularly to a device that is capable of limiting the pivotal travel of a window sash. It also relates to a window assembly including the same.

### BACKGROUND

Window openings present several safety concerns as they can lead to an accidental egress of individuals possibly leading to a fall causing serious injury. Several preventive features are known for use within residential homes including adjusting the height of the window at the time of installation to prevent access to small children and inhibit an accidental fall therefrom.

Alternatively, window opening control devices can be retrofitted to existing windows to releasably limit the travel that a window sash may undergo to a relatively small amount (for instance, in accordance with certain regulations, below four inches). Such devices can similarly be utilized to prevent unauthorized entry into a dwelling from the outside by an intruder. However, preventative measures in the form of window opening control devices have not been pursued as vigorously for casement windows, which typically are hingedly connected in some fashion to a window frame. The ability of casement windows can advantageously be opened so as to fully expose the window opening. However, this presents additional risks as larger objects can fit through the opening.

At times, there may be a need to override the window opening limit device so that the casement window can be opened beyond the limited position. In particular, it may be necessary to fully open the window. During an emergency, for example, a window opening may provide an escape route for individuals or an access route for emergency personnel. Accordingly, building and residential codes may require window opening limit devices to be equipped with a release mechanism. The need may also exist that such window opening limit devices be operable without keys, tools, or special knowledge and deter or prevent operation by young children.

Unless the window opening control device is reengaged once released, casement windows could potentially be operated so as to allow the window opening to be fully exposed. Subsequent users, for example, may not realize that the window is equipped with such a device or that the device has been released. Therefore, there exists a need for window opening limit devices to possess the capability to be self re-engaging even if a user does not intend to reengage the device through the user's actions.

In view of the above, there is a need for a window opening control device which would be able to overcome or at least minimize some of the above-discussed prior art concerns.

### SUMMARY

In accordance with an aspect, there is provided a window opening control device, comprising:
a first restrictor arm having a proximal end pivotably securable to one of a window frame and a window sash and including a first connector;
a second restrictor arm having a proximal end pivotably securable to the other one of the window frame and the window sash and including second connector couplable with the first connector, the first and the second restrictor arms being configurable in a compacted configuration wherein they are superposed to one another and an extended configuration wherein they are connected by the first and second connectors being coupled together to limit a pivotal travel of the window sash with respect to the window frame; and
a release mechanism mounted to one of the first and second restrictor arms and actionable to disengage the first and the second connectors, the first and the second connectors being automatically coupled together in the compacted configuration.

According to an embodiment, the first connector is a male connector and the second connector is a female connector couplable with the male connector to provide a pivotable connector connection in between.

According to an embodiment, the first restrictor arm comprises a mounting bracket securable to the one of the window frame and the window sash, a first elongated arm pivotally mounted to the mounting bracket, and a flange protruding from the first elongated arm and having the first connector provided thereon.

According to an embodiment, the second restrictor arm comprises a mounting bracket securable to the other one of the window frame and the window sash, a second elongated arm pivotally mounted to the mounting bracket and having the second connector provided thereon and the release mechanism mounted to the second elongated arm.

According to an embodiment, the release mechanism comprises a clamp pivotable between a released configuration and a locked configuration and a biasing member biasing the clamp towards the locked configuration.

According to an embodiment, each one of the first and second arm restrictors further comprises an elongated guide to bias a respective one of the elongated arms towards one another in a rest configuration wherein the first and second arm restrictors are uncoupled.

According to an embodiment, the first connector is a male connector, and the second connector is a female connector couplable with the male connector to provide a pivotable connector connection inbetween.

According to an embodiment, the first restrictor arm comprises a first mounting bracket securable to the one of the window frame and the window sash, and a first elongated arm pivotally mounted to the first mounting bracket, the first elongated arm having the first connector provided thereon.

According to an embodiment, the first restrictor arm comprises a resilient member configured to pivotally bias the first elongated arm towards the one of the window frame and the window sash wherein the first elongated arm superposes the one of the window frame and the window sash.

According to an embodiment, the first restrictor arm comprises an abutment shaped to space-apart the first elongated arm from the one of the window frame and the window sash when the first elongated arm superposes the one of the window frame and the window sash.

According to an embodiment, the second restrictor arm comprises a second mounting bracket securable to the other one of the window frame and the window sash, a second elongated arm pivotally mounted to the second mounting bracket and having the second connector provided thereon, and the release mechanism mounted to the second elongated arm.

According to an embodiment, the second arm restrictor comprises a resilient member configured to pivotally bias the second elongated arm into a coupling angle wherein the second connector of the second arm restrictor is in a coupling alignment with the first connector of the first arm restrictor when the first and second arm restrictors are uncoupled.

According to an embodiment, at least one of the first and second mounting brackets is a corner bracket securable to a corner portion of the respective one of the window frame and the window sash to align the first and second restrictor arms when in the compacted configuration.

According to an embodiment, the release mechanism comprises a sliding member movable between a release configuration and a locked configuration, and a biasing member biasing the sliding member towards the locked configuration.

According to an embodiment, the second connector is a locking aperture extending through the second elongated arm and being at least partially delimited by the sliding member when the sliding member is in the locked configuration.

According to an embodiment, the sliding member comprises a projection extending along a periphery of the locking aperture when the sliding member is in the locked configuration to at least partially delimit the locking aperture.

According to an embodiment, the first connector is a locking member sized to be received within the locking aperture when the first and second connectors are coupled together.

According to an embodiment, the first connector further comprises a head portion provided at a distal end of the locking member and spaced-apart from the first elongated arm to define a head gap sized to receive second elongated arm.

According to an embodiment, the locking aperture defines a concave channel at a distal end thereof sized to receive the first connector therein when the first and second arm restrictors are tensioned in the extended configuration.

According to an embodiment, the second elongated arm comprises a pointed distal tip sized for insertion between a gap formed between the first connector and the one of the window frame and the window sash when the first elongated arm is in a rest position.

In accordance with an aspect, there is provided a window assembly comprising:
a window frame;
a window sash pivotably mounted to the window frame; and
a window opening control device as recited above.

In accordance with an aspect, there is further provided a method of restricting a window opening, the method comprising:
securing a first arm restrictor to a window frame, the first arm restrictor being pivotally mounted to the window frame;
securing a second arm restrictor to a window sash, the second arm restrictor being pivotally mounted to the window sash;
configuring the window sash in a closed configuration to automatically couple a first connector of the first arm restrictor with a second connector of the second arm restrictor and the first and second restrictor arms are superposed; and
biasing at least one of the first and the second connectors in the coupled configuration.

In accordance with an aspect, there is further provided a method of restricting a window opening, the method comprising:
securing a first arm restrictor to a window frame, the first arm restrictor comprising a first connector and being pivotally mounted to the window frame;
securing a second arm restrictor to a window sash, the second arm restrictor comprising a second connector and being pivotally mounted to the window sash;
pivotally biasing the first arm restrictor toward the window frame to superpose the window frame;
pivotally biasing the second arm restrictor to position the second connector of the second arm restrictor in a coupling alignment with the first connector of the first arm restrictor; and
pivoting the window sash in a closed configuration to automatically couple the first connector of the first arm restrictor with the second connector of the second arm restrictor and the first and second restrictor arms are superposed.

According to an embodiment, coupling the first and second connectors comprises transitioning a release mechanism of one of the first and second connectors from a locked configuration to a release configuration to expose an open lateral side of a locking aperture of a corresponding one of the first and second connectors.

According to an embodiment, transitioning the release mechanism from the locked configuration to the release configuration comprises sliding a sliding member along a longitudinal axis of the corresponding one of the first and second arm restrictors.

According to an embodiment, the method further comprises pivoting the window sash outwardly until the displacement of the window sash is constrained by the coupling of the first and second arm restrictors.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a top perspective view of a window opening control device in accordance with an embodiment, mounted to a window assembly including a window frame and a window sash and configured in an extended configuration;

FIG. 2 is a top perspective view of a section of a first arm restrictor of the window opening control device of FIG. 1 in accordance with an embodiment, mounted to the window frame;

FIG. 3 is a front side perspective view of a second arm restrictor coupled with the first arm restrictor of the window opening control device of FIG. 1 in accordance with an embodiment, the second arm restrictor being mounted to the window sash;

FIG. 4 is a top perspective view of the window opening control device of FIG. 1, wherein the first and second arm restrictors are uncoupled and the window sash is in an open configuration;

FIG. 5 is a side elevation view of the window opening control device of FIG. 1, configured in a compacted configuration;

FIG. 6 is a perspective view, exploded, of the window opening control device of FIG. 1;

FIG. 7 is a perspective view of the window opening control device of FIG. 1, wherein the first and second arm restrictors are uncoupled;

FIG. 8 is a perspective view, sectioned, of portions of the first and second arm restrictors of the window opening control device of FIG. 1, prior to coupling;

FIG. 9 is a perspective view of the window opening control device of FIG. 1, wherein the first and second arm restrictors are uncoupled;

FIG. 10 is a perspective view of the window opening control device of FIG. 1, wherein in an almost compacted configuration and before coupling of the first and second arm restrictors;

FIG. 11 is a bottom side elevation of the window opening control device in accordance with another embodiment, shown in the compacted configuration and wherein the first and second arm restrictors are coupled together and wherein a locking aperture has an irregular shape;

FIG. 12 is a top perspective of the window opening control device of FIG. 11, shown in the compacted configuration and wherein the first and second arm restrictors are coupled together;

FIG. 13 is a bottom side elevation view of the window opening control device of FIG. 11, shown in an almost extended configuration;

FIG. 14 is a bottom perspective view of the window opening control device of FIG. 1, shown in the extended configuration;

FIG. 15 is a bottom perspective view of the window opening control device of FIG. 1, shown in the extended configuration and wherein a release mechanism is configured in a locked configuration;

FIG. 16 is a bottom perspective view of the window opening control device of FIG. 1, shown in the extended configuration and wherein the release mechanism is configured in a released configuration;

FIG. 17 is a top perspective view of a window opening control device in accordance with another embodiment, shown in an extended configuration;

FIG. 18 is a bottom perspective view of the window opening control device of FIG. 17;

FIG. 19 is a perspective view, exploded, of the window opening control device of FIG. 17;

FIG. 20 is a top perspective view of the window opening control device of FIG. 17, wherein the first and second arm restrictors are uncoupled;

FIG. 21 is a bottom perspective view of the window opening control device of FIG. 20;

FIG. 22 is a top perspective of the window opening control device of FIG. 17, configured in a compacted configuration;

FIG. 23 is a top plan view of the window opening control device of FIG. 17, mounted to a window assembly including a window frame and a window sash, in a first step of a coupling method;

FIG. 24 is a top plan view of the window opening control device of FIG. 23, in a second step of a coupling method;

FIG. 25 is a top plan view of the window opening control device of FIG. 23, in a third step of a coupling method;

FIG. 26 is a top plan view of the window opening control device of FIG. 23, in a fourth step of a coupling method;

FIG. 27 is a top plan view of the window opening control device of FIG. 23, in a fifth step of a coupling method;

FIG. 28 is a top perspective view of the window opening control device of FIG. 17, mounted to a window assembly including a window frame and a window sash, in a first step of a decoupling method;

FIG. 29 is a top perspective view of the window opening control device of FIG. 23, in a second step of a decoupling method;

FIG. 30 is a top perspective view of the window opening control device of FIG. 23, in a third step of a decoupling method;

FIG. 31 is a top perspective view of the window opening control device of FIG. 23, in a fourth step of a decoupling method;

FIG. 32 is a perspective view of a second arm restrictor of the window opening control device of FIG. 17, in accordance with an embodiment;

FIG. 33 is a top perspective view of the second arm restrictor of FIG. 32;

FIG. 34 is a side perspective view of the second arm restrictor of FIG. 32;

FIG. 35 is a top plan view of the window opening control device of FIG. 17, mounted to a window assembly including a window frame and a window sash, in a first step of a coupling method;

FIG. 36 is a top plan view of the window opening control device of FIG. 35, in a second step of a coupling method; and

FIG. 37 is a top plan view of the window opening control device of FIG. 35, in a third step of a coupling method.

It will be noted that throughout the appended drawings, like features are identified by like reference numerals.

### DETAILED DESCRIPTION

Although the embodiments of the window opening control device and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the window opening control device, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

Furthermore, in the context of the present description, it will be considered that all elongated objects will have an implicit “longitudinal axis” or “centerline”, such as the longitudinal axis of an elongated member for example, or the centerline of a biasing device such as a coiled spring, for example, and that expressions such as “connected” and “connectable”, “secured” and “securable”, “engaged” and “engageable”, “installed” and “installable” or “mounted” and “mountable”, may be interchangeable, in that the present sweeping sash also relates to kits with corresponding components for assembling a resulting fully-assembled and fully-operational window opening control device.

It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

Moreover, components of the window opening control device and/or steps of the method(s) described herein could be modified, simplified, altered, omitted and/or interchanged, without departing from the scope of the present disclosure, depending on the particular applications which the present window opening control device is intended for, and the desired end results, as briefly exemplified herein and as also apparent to a person skilled in the art.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

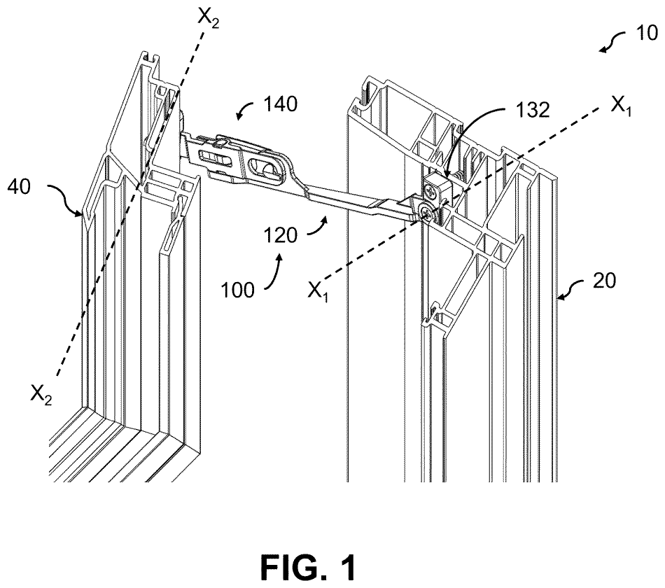

The present disclosure describes a window opening control device configured to be mounted to a window assembly and, more particularly, to limit the travel that a window sash of the window assembly may undergo with respect to a window frame. Referring now to the drawings and more particularly to FIGS. 1 to 5, there is shown an embodiment of a window assembly 10 configured to receive a window opening control device 100 (hereinafter, the “opening control device”) in accordance with a non-limitative embodiment. Only a portion of the window assembly 10 is shown. The window assembly 10, which is a casement window assembly, includes a window frame 20 and a window sash 40. The window sash 40 is pivotably mounted to the window frame 20 via at least one hinge (not shown) such as to enable outwardly pivotal travelling of the window sash 40 with respect to the window frame 20 between a closed configuration and a plurality of open configurations.

It is appreciated that while the window frame 20 and the window sash 40 are shown as being extruded, the window frame 20 and the window sash 40 can be manufactured in accordance with any known method using any suitable material including, for instance, wood, vinyl, fiberglass and/or aluminum.

In the description and in reference to the window assembly 10 and/or the opening control device 100, the terms “outwardly” and “inwardly” refer to a position of a component of the window sash 40, or the opening control device 100 with a position of the window frame 20 as a reference point, and with “outwardly” meaning away from the window frame 20.

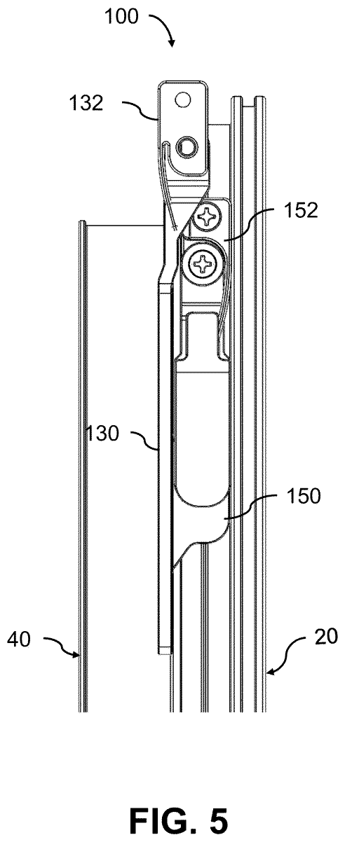

It should also be noted that the expression “pivotal travel of the window sash 40” or “travelling” or any equivalent expression used herein refers to a displacement of the window sash 40 by pivoting on at least one axis defined by an operational connection of the window sash 40 with the window frame 20, such as a hinge, thus providing pivotal movement of the window sash 40 relative to the window frame 20. It should also be noted that the expressions “opening” or “spacing” of the window sash 40 refers to a distance between distant side edges of the window sash 40 and window frame 20 as a result of the pivotal travel of the window sash 40. For instance, the opening of the window sash 40 shown in FIG. 5 is null (i.e., the window sash 40 is said to be in the closed configuration).

The opening control device 100 includes two arm restrictors 120, 140, each one being pivotally securable at a proximal end thereof to a respective one of the window frame 20 and the window sash 40. Each one of the arm restrictors 120, 140 includes a connector 122, 142 at or close to a distal end thereof. In the embodiment shown, the first arm restrictor 120 includes a male connector 122 and the second arm restrictor 140 includes a female connector 142 couplable with the male connector 122. Even when coupled together, the first and the second arm restrictors 120, 140 can pivot relative to one another at a connector connection, as will be described in more detail below. In the embodiment shown, the first arm restrictor 120 including the male connector 122 is pivotally mounted to the window frame 20 and the second arm restrictor 140 including the female connector 142 is pivotally mounted to the window sash 40. However, it is appreciated that the first arm restrictor 120 can be mounted to the window sash 40 and the second arm restrictor 140 can be mounted to the window frame 20 in an alternative embodiment (not shown).

It should be noted that the terms “proximal” and “distal”, as used below in the context of the first and the second arm restrictors 120, 140, refer to a position relative the window frame 20 or the window sash 40 to which the corresponding arm restrictor 120, 140 is pivotally mounted with an attachment point as a reference point, and with a proximal position being closer to the respective one of the window frame 20 and the window sash 40, than a distal position.

In the embodiment shown, the first arm restrictor 120 includes a mounting bracket 132 secured to the window frame 20, via one or more mechanical fastener(s) for instance, and having a first elongated arm 130 pivotally mounted to the mounting bracket 132 and pivotable about an axis X₁-X₁. In a rest position, the first elongated arm 130 pivots downwardly towards the window frame 20 by gravity and is superposed thereto.

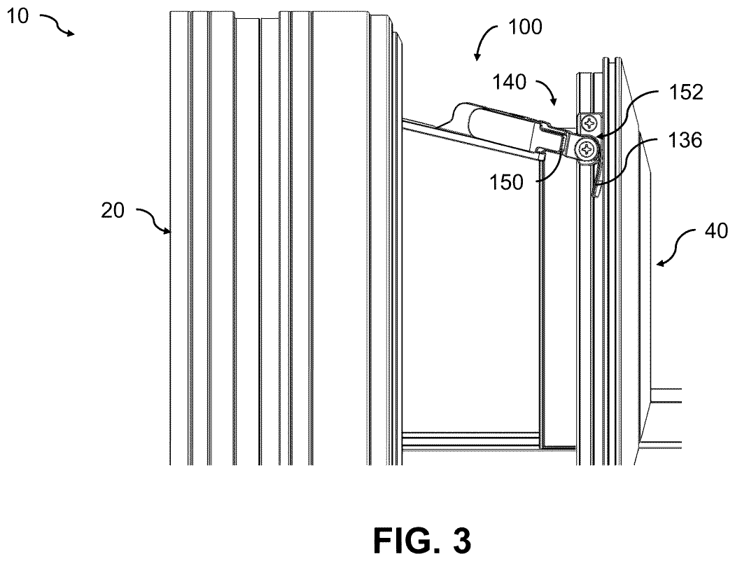

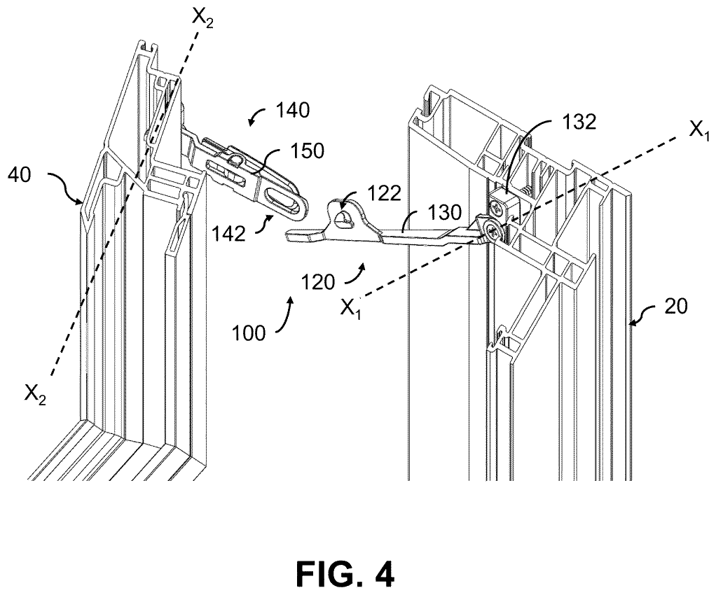

Referring to FIG. 3, there is shown that, similar to the first arm restrictor 120, the second arm restrictor 140 includes a mounting bracket 152 secured to the window sash 40, via one or more mechanical fastener(s) for instance, and having a second elongated arm 150 pivotally mounted to the mounting bracket 152 and pivotable about an axis X₂-X₂ (FIGS. 1 and 4). In a rest position, the second elongated arm 150 pivots downwardly towards a frame of the window sash 40 by gravity and is superposed thereto.

It is appreciated that the shape of the first and the second elongated arms 130, 150 and the mounting brackets 132, 152 can vary from the embodiment shown.

In the embodiment shown in FIG. 1, the mounting brackets 132, 152 of the first and second arm restrictors 120, 140 are mounted to the inner peripheral frame surface and outer peripheral frame surface of the window frame 20 and window sash 40, respectively, being adjacent to one another in the closed configuration of the window assembly 10.

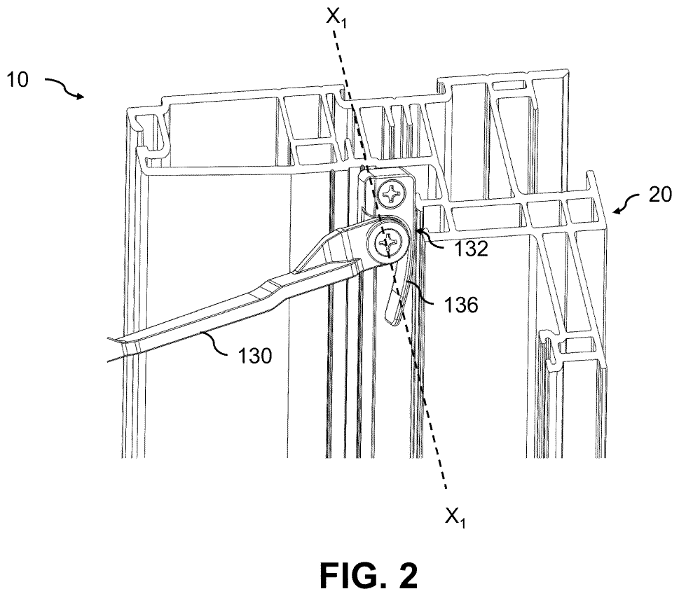

As it will be described in further details below, when the window assembly 10 is configured in the closed configuration, i.e. when the window sash 40 is located in the opening of the window frame 20, the first and the second arm restrictors 120, 140 are superposed in a compacted configuration (FIG. 5) and the first and second connectors 122, 142 are automatically coupled together. When the window assembly 10 is configured in one of the open configurations, as shown in FIG. 1, the first and second elongated arms 130, 150 of the first and second arm restrictors 120, 140 are pivoted upwardly about the connector connexion, about their respective pivoting axes X₁-X₁, X₂-X₂, towards an extended configuration (FIGS. 2 and 3) with their first and second connectors 122, 142 remaining coupled together and thereby, limiting the sash spacing. In a maximal opening (FIG. 1) of the window sash 40 with respect to the window frame 20 in the coupled configuration of the opening control device 100, the first and second elongated arms 130, 150 of the first and second arm restrictors 120, 140 are aligned, i.e. they extend parallel to one another and along a same axis, and only distal sections thereof, including their respective connectors 122, 142, are superposed. In the maximal opening of the window sash 40 with respect to the window frame 20, the opening control device 100 is configured in the extended configuration when the first and second arm restrictors 120, 140 are coupled together.

To further open the window assembly past the maximal opening, the first and second connectors 122, 142 must be manually disengaged from one another as shown in FIG. 4.

To be configurable between the compacted configuration and the extended configuration, the coupling between the first and second arm restrictors 120, 140 is pivotable. Thus, the connectors 122, 142 of the first and second arm restrictors 120, 140 define the pivotable connector connexion when coupled.

When coupled together, the first and second arm restrictors 120, 140 constrain travel of the movable window sash 40 with respect to the window frame 20. When the first and second arm restrictors 120, 140 are coupled together, the window sash 40 can travel inwardly towards the window frame 20 until the closed configuration of the window assembly 10 is reached and the opening control device 100 is configured in the compacted configuration, and outwardly until the displacement of the window sash 40 is constrained by the opening control device 100, i.e. in the extended configuration of the opening control device 100. Still when the first and second arm restrictors 120, 140 are coupled together, when the window sash 40 is pivoted towards the closed configuration, the first and second arm restrictors 120, 140 are pivoted downwardly about their respective pivoting axes X₁-X₁, X₂-X₂ and, when the window sash 40 is pivoted into one of the open configurations, the first and second arm restrictors 120, 140 are pivoted upwardly.

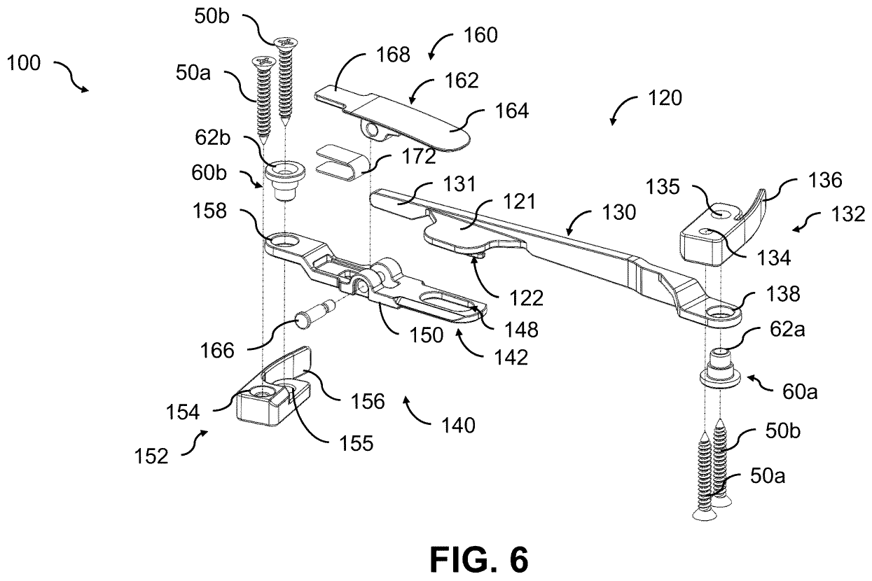

Referring now to FIGS. 6 to 8, a non-limitative embodiment of the first and second arms restrictors 120, 140 is described.

As mentioned above, the mounting brackets 132, 152 of the first and the second arm restrictors 120, 140 are mounted to the window and sash frames 20, 40 via mechanical fasteners, such as screws 50a, 50b. More particularly, in the embodiment shown, two screws 50a, 50b are used to mount each one of the first and the second arm restrictors 120, 140 to their respective frame 20, 40. It is appreciated that other mechanical fasteners can be used to secure the first and the second arm restrictors 120, 140 to the window and sash frames 20, 40, such as, and without being limitative, adhesives, rivets, carriage bolts, dowels, and nails.

A first screw 50a extends directly in a first aperture 134, 154 defined in the mounting bracket 132, 152. To provide at least one additional degree of freedom to the first and the second elongated arms 130, 150, each one of the first and the second arm restrictors 120, 140 further includes a resilient bushing 60a, 60b extending between a second screw 50b, the respective elongated arm 130, 150 and the respective mounting bracket 132, 152. More particularly, the resilient bushing 60a, 60b has an aperture 62a, 62b defined therein to receive the screw 50b and is insertable in a second aperture 135, 155 extending through the mounting bracket 132, 152 and an aperture 138, 158 extending through the elongated arm 130, 150. Therefore, the resilient bushing 60a, 60b can be compressed to allow movement of the first and the second elongated arms 130, 150 in other directions than the pivoting axes X₁-X₁, X₂-X₂ respectively. It is appreciated that other means can be provided to allow movement of the first and the second elongated arms 130, 150 in other directions than the pivoting axes X₁-X₁, X₂-X₂. For instance and without being limitative, the mechanical fasteners 50b can be inserted directly in a respective one of the aperture 138, 158 having a greater diameter than the screw diameter.

The mounting brackets 132, 152 of each one of the first and the second arm restrictors 120, 140 have an elongated guide 136, 156 protruding in direction of the rest position of its respective elongated arm 130, 150 when mounted to the window frame 20 and the window sash 40 respectively. As mentioned above, if uncoupled and released, each one of the elongated arms 130, 150 will fall downwardly towards their respective window and sash frames 20, 40 by gravity. In the rest configuration, each one of the elongated arms 130, 150 will abut against its respective elongated guide 136, 156, which will maintain them slightly spaced-apart from their respective window and sash frames 20, 40, ensuring that the connectors 122, 142 of the first and the second arm restrictors 120, 140 are automatically coupled together when the window assembly 10 is configured in the closed configuration.

In addition to the mounting bracket 132 to which the first elongated arm 130 is pivotally mounted, the first arm restrictor 120 includes a flange 121 protruding from the first elongated arm 130, and the connector 122 which is mounted to the flange 121. The flange 121 protrudes away from the window or sash frame 20, 40, to which the first elongated arm 130 is mounted. In the embodiment shown, the flange 121 protrudes away from the window frame 20 and towards the sash frame 40 in the closed configuration of the window assembly 10. It is appreciated that if the first arm restrictor 120 was mounted to the window sash 40, the flange 121 would protrude away from the window sash 40 and towards the window frame 20 in the configuration of the window assembly 10.

In the non-limitative embodiment shown, the flange 121 is not mounted to the distal end of the first elongated arm 130, but adjacent thereto, thereby defining a stopper section 131 extending past thereof and including the distal end of the first elongated arm 130. The purpose of the stopper section 131 will be described in more details below. It is appreciated that, in an alternative embodiment, the opening control device 100 can be free of the stopper section 131.

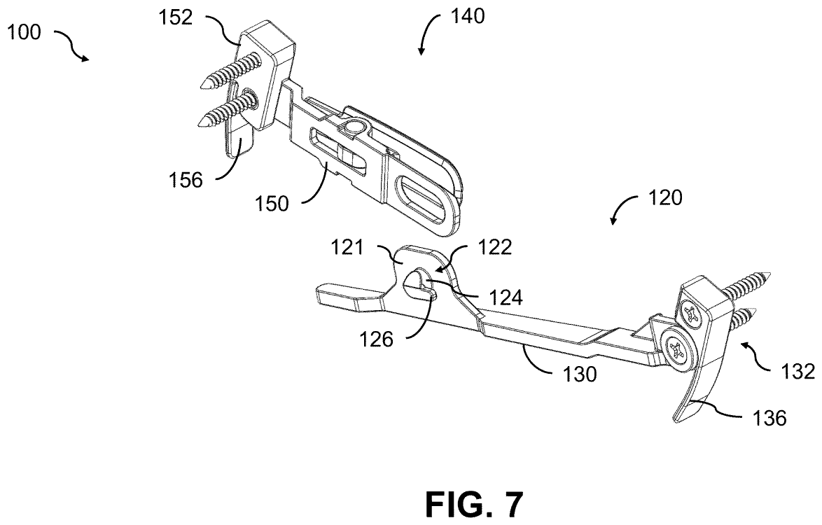

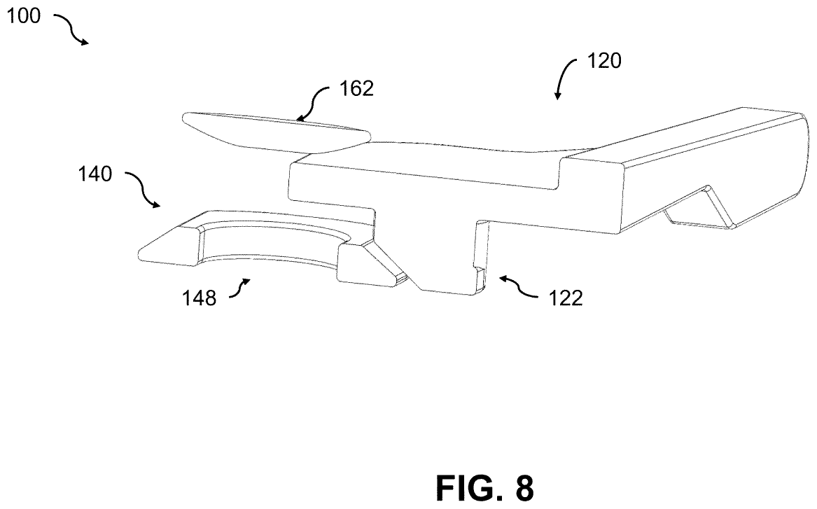

Turning now to FIG. 7, a non-limitative embodiment of the first connector 122, protruding from the flange 121, is shown. The first connector 122 is a male member having a whistle-like profile with a substantially spherical central portion 124 and a finger 126 protruding therefrom to act as a hook. The spherical central portion 124 is connected to the flange 121 while the finger 126 is spaced-apart therefrom (FIG. 8) by a “hook gap”, as will be described in more details below. In such embodiments, the first connector 122 can be referred to as a hook connector 122.

The finger 126 is oriented towards the mounting bracket 132 of the first arm restrictor 120, extending substantially parallel to the first elongated arm 130. The spherical central portion 124 has a tapered section to ease its engagement with the second arm restrictor 140, as will be described in more details below.

It is appreciated that the connector 122 of the first arm restrictor 120 can have a different shape and/or configuration than the hook connector 122 shown. For instance, and without being limitative, the number, shape, configuration, and location of the hook connector 122 can vary from the implementation shown. For instance, the term “hook” can include a semi-circle hook or the finger 126 can be replaced by a strut or a tooth. The hook connector 122 can also be embodied by a piece or accessory not commonly specified as a “hook”, such as a clip, a rib, or a link. Any attachment means is contemplated herein so long as the connector substitute enables a detachable and pivotable connection with the connector of the second arm restrictor 140.

Referring back to FIG. 6, in addition to the mounting bracket 152 to which the second elongated arm 150 is pivotally mounted, the second arm restrictor 140 includes a clamp 162 pivotally mounted to the second elongated arm 150 via a pivot axle 166, defining a pivoting axis, extending through apertures defined in both the second elongated arm 150 and the clamp 162. The pivoting apertures extending through the clamp 162 and aligned with the pivoting axis divides the clamp 162 into a proximal section 168 including a proximal end and a distal section 164 including a distal end. The distal end of the clamp 162 is biased on and towards the distal end of the second elongated arm 150.

The second arm restrictor 140 includes a biasing member 172, which in the non-limitative embodiment shown in FIG. 6 is a U-shape spring, mounted between the second elongated arm 150 and the proximal end of the clamp 162 to bias the distal end of the clamp 162 towards the distal end of the second elongated arm 150. It is appreciated that the biasing member 172 can vary from the embodiment shown. For instance and without being limitative, a coiled spring can be used.

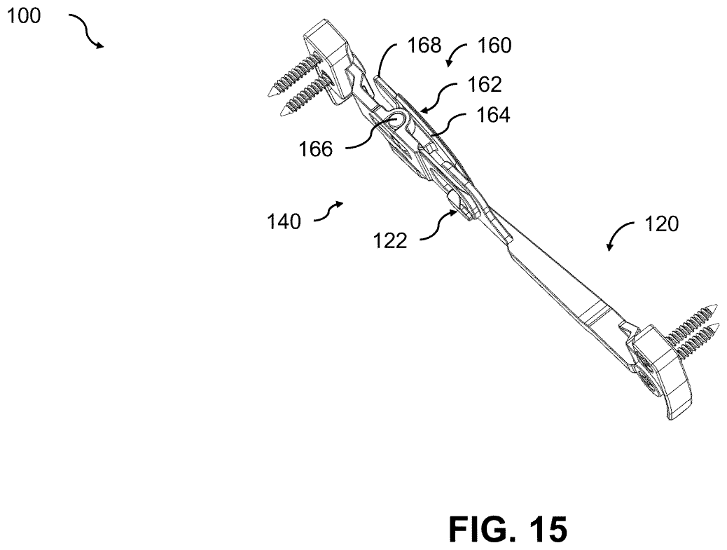

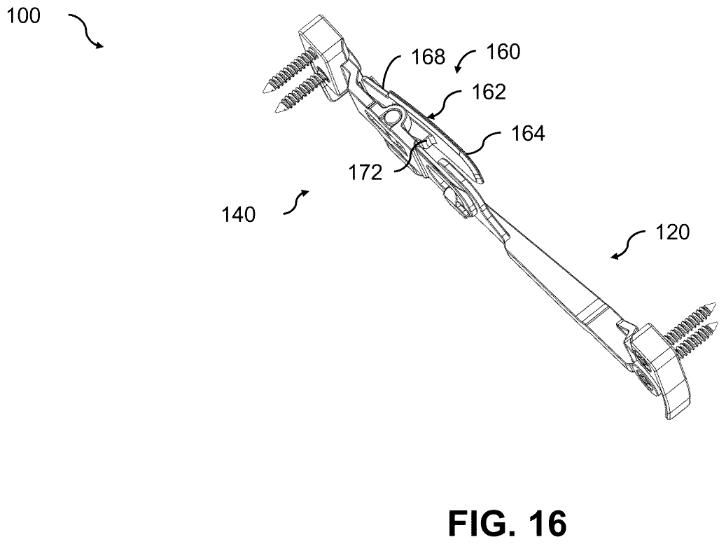

A combination of the clamp 162 and the biasing member 172 defines a retention mechanism to ensure that the connectors 122, 142 remain coupled together and a release mechanism 160 to uncouple the connectors 122, 142, as will be described in more details below. The clamp 162 is selectively configurable in a released configuration (FIG. 16) wherein pressure is applied onto its proximal end to lift the distal end, and a locked configuration (FIG. 15) wherein its distal end is biased towards the distal end of the second elongated arm 150, as will be described in more details below. In the embodiment shown, the release/retention mechanism 160 is mounted to the second arm restrictor 140. However, it is appreciated that, in an alternative embodiment (not shown), the release/retention mechanism 160 can be mounted to the first arm restrictor 120.

In the non-limitative embodiment shown, the second connector 142 is a locking aperture 148 defined in the second elongated arm 150 and extending therethrough. In the non-limitative embodiment shown, the locking aperture 148 has an oblong shape. It is appreciated that the nature, the size, the shape, and the configuration of the second connector 142 can vary from the embodiment shown.

As mentioned above, in the coupled configuration of the first and second connectors 122, 142, the hook connector 122 is insertable in the locking aperture 148. Therefore, the hook gap is about equal or greater than a depth of the locking aperture 148 (i.e., a thickness of the second elongated arm 150 around the locking aperture 148). Thus, the hook connector 122 is insertable through the locking aperture 148 and configurable in a manner such that the second elongated arm 150, around the locking aperture 148, can slide in the “hook gap” to pivotally couple the first and second arm restrictors 120, 140.

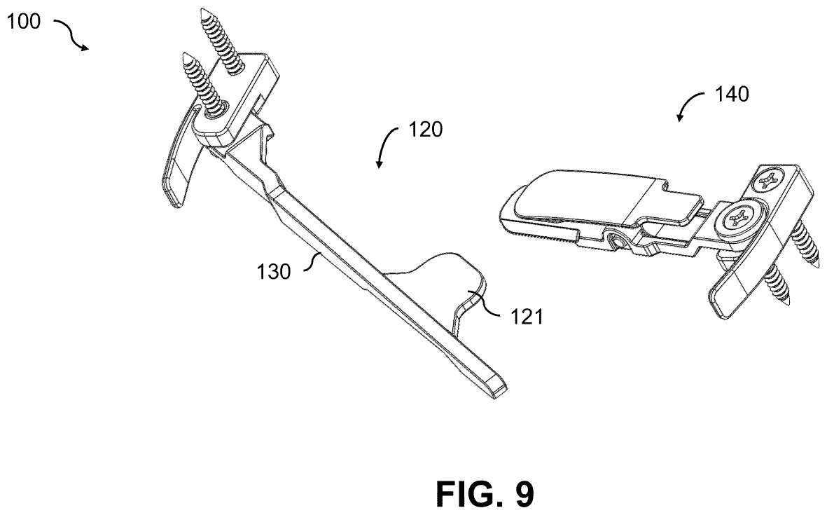

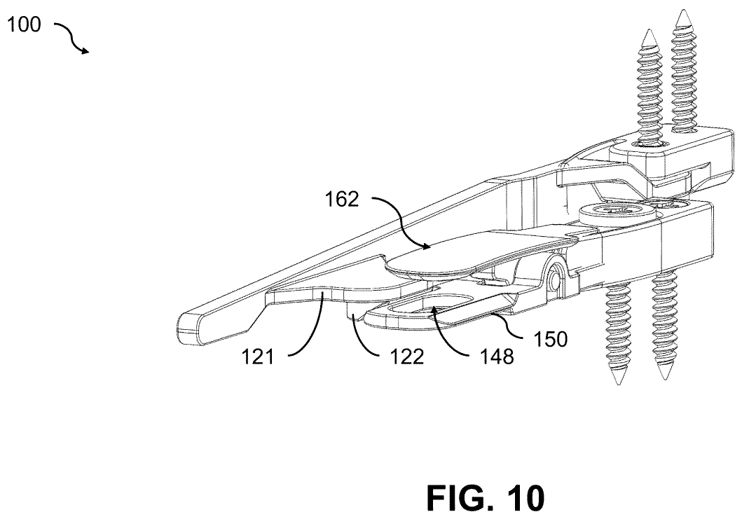

Referring now to FIGS. 7, 9, and 10, the first and the second arm restrictors 120, 140 are shown uncoupled. The flange 121 of the first arm restrictor 120 is oriented towards the second arm restrictor 140 to be insertable between the second elongated arm 150 and the clamp 160, with the hook connector 122 of the first arm restrictor 120 protruding towards the connector 142 of the second arm restrictor 140 and, more particularly, the oblong locking aperture 148. FIG. 10 shows the opening control device 100 just before coupling of the two connectors 122, 142. FIG. 8 is a cross-sectional view of a portion thereof. The first and the second arm restrictors 120, 140 are almost configured in the compacted configuration wherein their elongated arms 130, 150 extend substantially parallel to one another. In the almost compacted configuration, the flange 121 of the first arm restrictor 120 extends substantially parallel to the second elongated arm 150 and the clamp 162 of the second arm restrictor 140. The flange 121 is aligned with a gap defined between the second elongated arm 150 and the clamp 162. The first connector 122 of the first arm restrictor 120 is substantially aligned with the second connector 142 of the second arm restrictor 140, i.e. the locking aperture 148. Furthermore, the tapered section of the hook connector 122 is oriented towards the elongated arm 150 of the second arm restrictor 140 to ease the engagement between the second elongated arm 150 and the clamp 162 (FIG. 8).

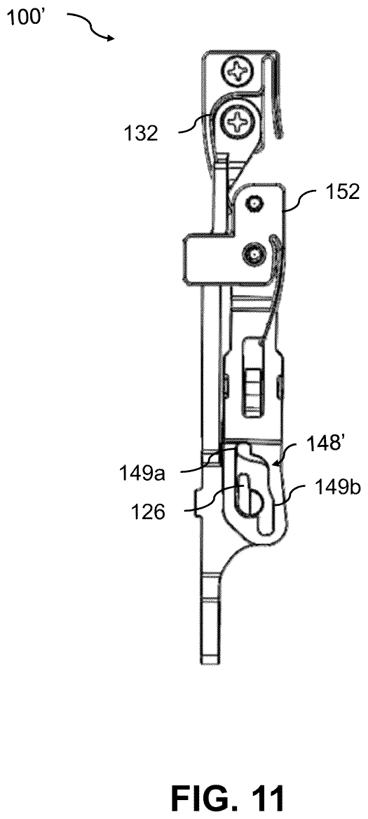

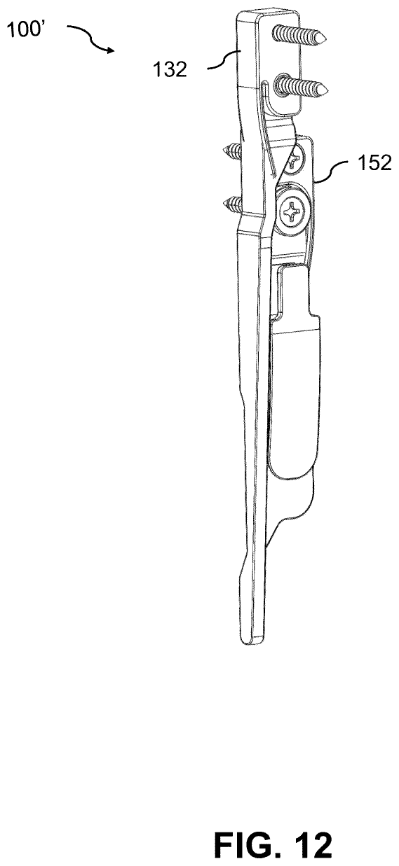

FIG. 11 shows an alternative embodiment to the opening control device 100′ shown in FIGS. 1 to 10, wherein the features are identified by the same reference numerals, except regarding the shape of the locking aperture 148 of the second arm restrictor 140. The locking aperture 148′ has an essentially oblong shape but with elongated channels 149a, 149b protruding at both extremities, the purpose of which will be described in more detail below. FIGS. 11 and 12 show the opening control device 100′ in the compacted configuration wherein the two connectors 122, 142 are automatically coupled together. The clamp 162 being biased towards the flange 121 in the coupled configuration, undesirable disengagement of the two connectors 122, 142 is thereby substantially prevented.

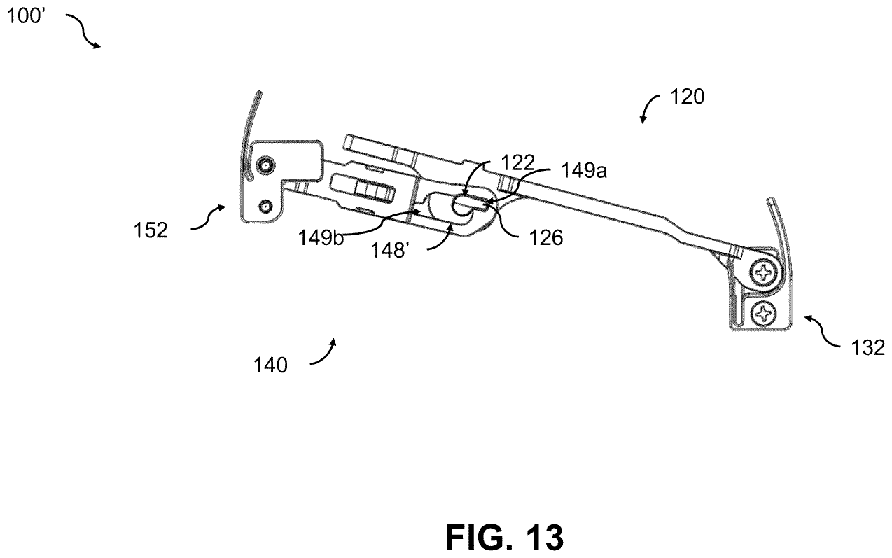

Turning now to FIG. 13, there is shown the opening control device 100′ of FIG. 11 is an almost extended configuration, i.e. to the maximum opening in the coupled configuration. The finger 126 of the hook connector 122 has modified its orientation with respect to the second arm restrictor 140, pointing towards the mounting bracket 152 of the second arm restrictor 140 in the compacted configuration of FIG. 11 to pointing towards the mounting bracket 132 of the first arm restrictor 120 in the almost extended configuration of FIG. 13. Therefore, as mentioned above, when coupled together, the connectors 122, 142 of the first and the second arm restrictors 120, 140 allow a relative rotation. The rotation of the hook connector 122 inside the locking aperture 148 is guided by an inner peripheral edge delimitating the locking aperture 148, with the finger 126 extending mostly in a marginal edge region surrounding the locking aperture 148 along a rotation path of the connector 122. In the extended configuration of the opening control device 100′, the finger 126 is almost aligned with the elongated channel 149b, with a portion thereof extending above the flange 121.

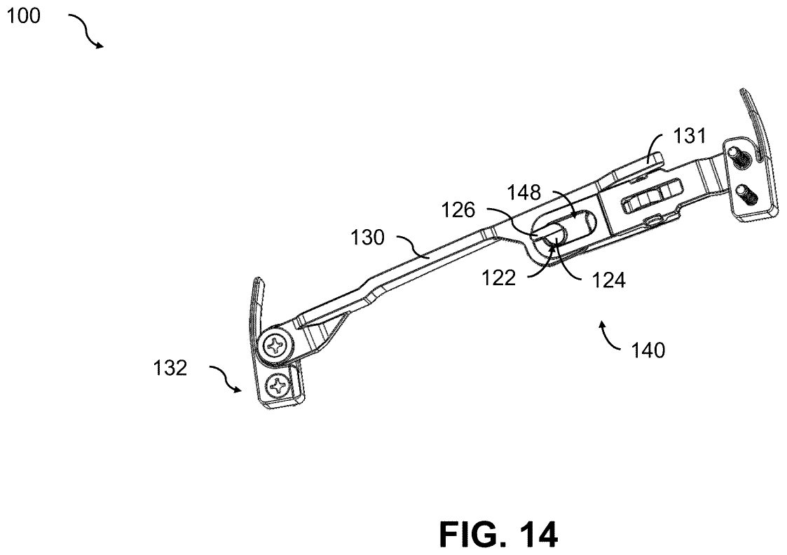

When the extended configuration is reached, as shown in FIG. 14, the stopper section 131 of the first arm restrictor 120 will abut against the second elongated arm 150 and will prevent the opening control device 100, 100′ to pivot past the extended configuration.

To uncouple the opening control device 100, 100′ in the extended configuration, pressure is applied to the proximal section 168 of the clamp 162, which acts as a release lever, to configure the clamp 162 from the locked configuration shown in FIG. 15 to the released configuration shown in FIG. 16, at least one of the first and the second elongated arms 130, 150 is displaced to free the hook connector 122 from the locking aperture 148. In the released configuration, the clamp 162 is spaced-apart from the flange 121 located between the clamp 162 and the second elongated arm 150, thereby providing an extra spacing to free the hook connector 122 engaged with the connector 142 of the second arm restrictor 140. As mentioned above, the resilient bushings 60a, 60b allow this additional movement of the first and the second elongated arms 130, 150 with respect to the window and sash frame 20, 40.

The locking aperture 148′ having the elongated channels 149a, 149b as shown in FIGS. 11 to 13 is provided with an extra spacing to ease the uncoupling of the hook connector 122 from the locking aperture 148′.

In the embodiments shown in the figures and described above, the opening control device 100, 100′ is mounted to a side-hung pivotable window. However, the opening control device 100, 100′ can be compatible with several window assemblies and is not limited to the type of window assembly 10 illustrated herein. For instance, the opening control device 100, 100′ can be adapted to be installed with an awning window assembly, in which the window sash is generally pivotably connected on a hinge mounted to a horizontal top or bottom edge of the window frame.

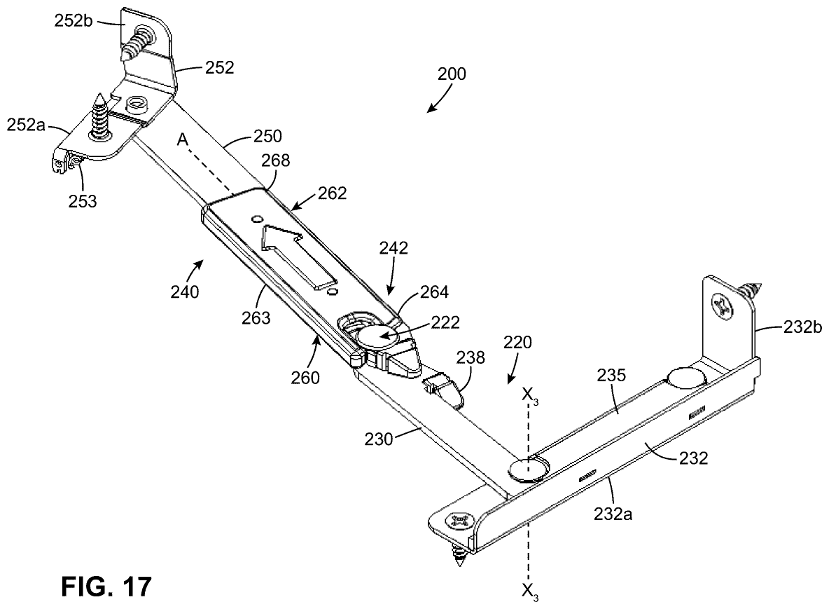

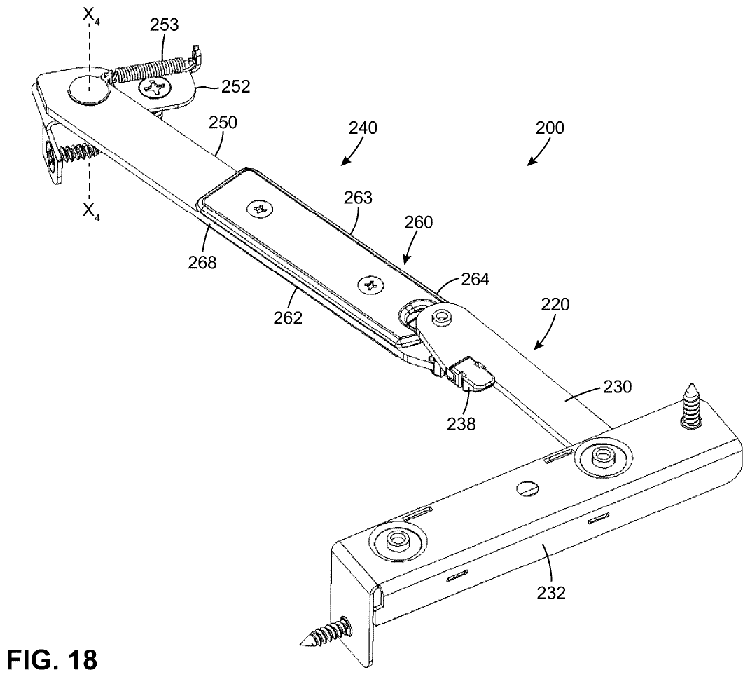

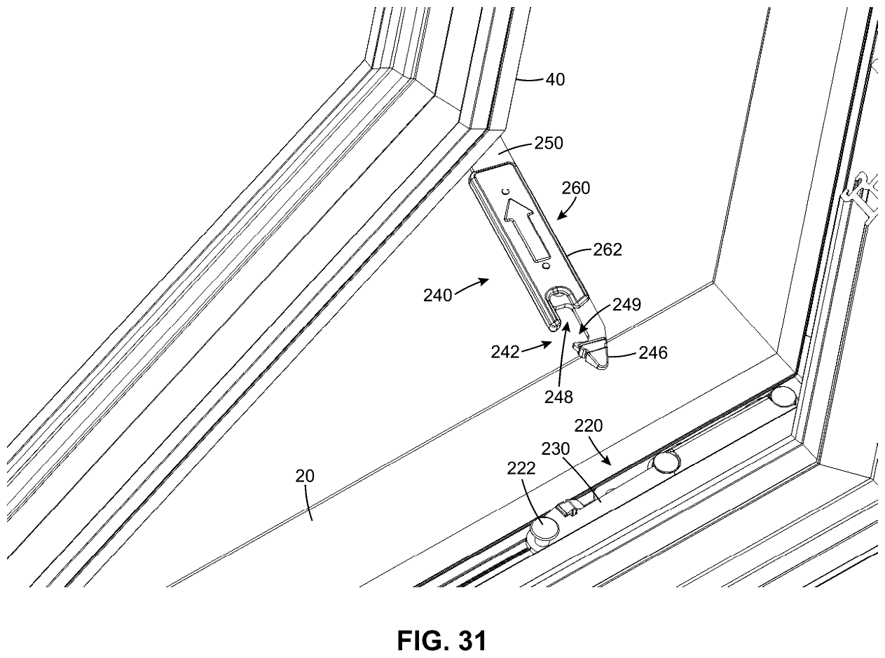

Referring to FIGS. 17 to 31, there is shown a window opening control device 200 in accordance with another non-limitative embodiment mounted to a window assembly 10. The opening control device 200 includes two arm restrictors 220, 240, each one being pivotally securable at a proximal end thereof to a respective one of the window frame 20 and the window sash 40. Each one of the arm restrictors 220, 240 includes a connector 222, 242 at or close to a distal end thereof. In the embodiment shown, the first arm restrictor 240 includes a male connector 222 and the second arm restrictor 240 includes a female connector 242 couplable with the male connector 222. Even when coupled together, the first and the second arm restrictors 220, 240 can pivot relative to one another at about the male and female connectors 222, 242, respectively, as will be described in more detail below. It will be appreciated that while, in the embodiment shown in FIGS. 17 to 31, the first arm restrictor 220 including the male connector 222 is shown pivotally mounted to the window frame 20 and the second arm restrictor 240 including the female connector 242 is shown pivotally mounted to the window sash 40, in other embodiments (not shown), the first arm restrictor 220 can be mounted to the window sash 40 and the second arm restrictor 240 can be mounted to the window frame 20.

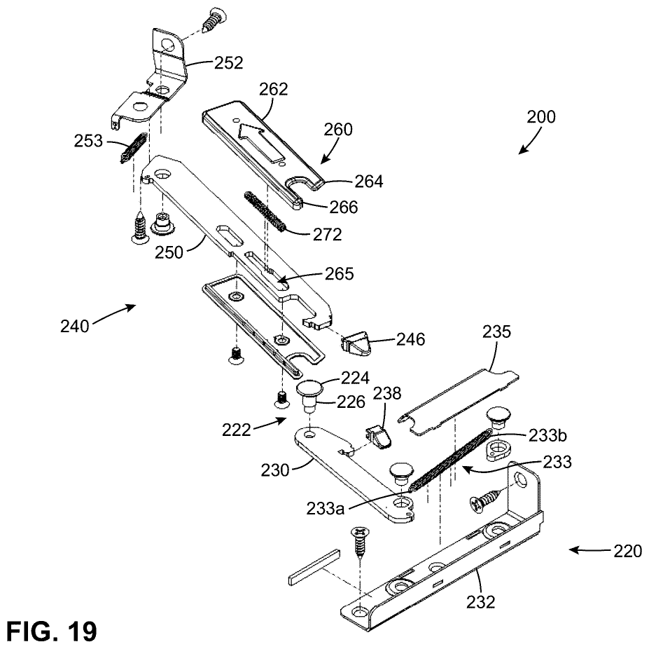

In the non-limitative embodiment shown, the first arm restrictor 220 includes a mounting bracket 232 secured to the window frame 20, via one or more mechanical fastener(s) for instance, and having a first elongated arm 230 pivotally mounted to the mounting bracket 232 and pivotable about an axis X₃-X₃. In a rest position (i.e., when the first and second elongated arms are uncoupled), the first elongated arm 230 can be configured to pivot towards the window frame 20 so as to superpose the window frame 20. In certain embodiments, the first elongated arm 230 can pivot towards the frame of the window frame 20 due to gravitational forces such as, for instance, when the mounting bracket 232 is secured to a vertical surface of the window frame 20. Alternatively, in other embodiments, the first arm restrictor 220 can include a resilient member 233 (shown in FIG. 19) configured to bias the first elongated arm 230 into the rest position. In the embodiment shown, the resilient member 233 is a tension spring having a first end 233a secured to the first elongated arm 230, and a second end 233b secured to the mounting bracket 232. It is appreciated that the resilient member 233 can vary from the embodiment shown. For instance and without being limitative, a torsion spring can be used. The resilient member 233 may thus bias the first elongated arm 230 into the rest position without reliance on gravitational forces thus enabling the first arm restrictor 220 to be mounted onto a horizontal surface of the window frame 20.

In the non-limitative embodiment shown, the first arm restrictor 220 further includes an abutment 238 secured to the first elongated arm 230. The abutment 238 is sized and shaped to slightly space-apart the first elongated arm 230 from the window frame 20 when the first arm restrictor 220 is in the rest position so as to prevent or limit damage to the window frame 20 during actuation of the window opening control device 200. The abutment 238 can be manufactured in accordance with any known method using any suitable material including, for instance, plastic, wood, vinyl, fiberglass and/or aluminum.

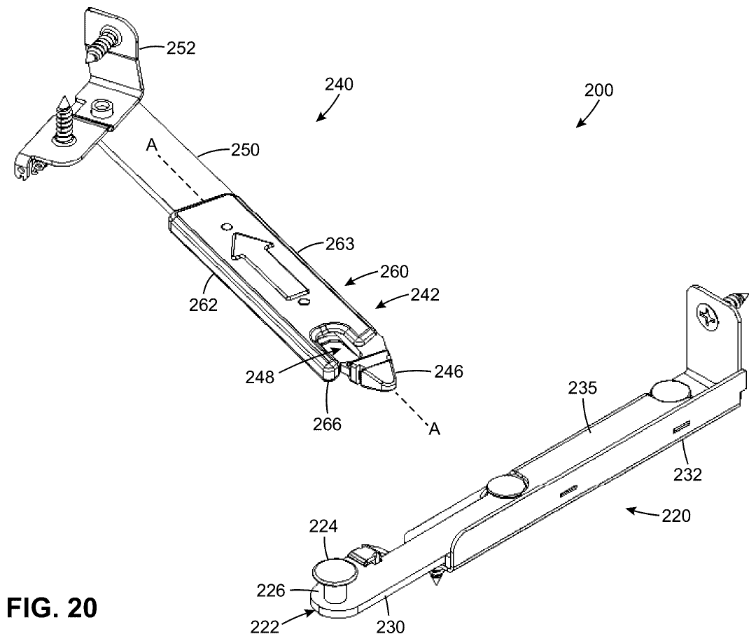

Turning now to FIGS. 19 and 20, a non-limitative embodiment of the male connector 222, protruding from the first elongated arm 230, is shown. The male connector 222 includes a substantially pin-shaped male locking member 226 protruding from the first elongated arm 230 in a direction away from the frame of the window frame 20 when the first elongated arm 230 is in the rest position. As stated above, the male connector 222 is disposed at or close to a distal end of the first arm restrictor 220 and, more specifically, at or close to a distal end of the first elongated arm 230. In certain embodiments, the male connector 222 further includes an enlarged head portion 224 at a distal end of the locking member 226 and spaced-apart from the first elongated arm 230 by a “head gap”, as will be described in more details below.

Referring to FIGS. 17 to 21, the second arm restrictor 240 includes a mounting bracket 252 securable to the window sash 40, via one or more mechanical fastener(s) for instance, and having a second elongated arm 250 pivotally mounted to the mounting bracket 252 and pivotable about an axis X₄-X₄. In a rest position, when the first and second arm restrictors 220, 240 are uncoupled, the second elongated arm 250 can be configured to pivot towards the frame of the window sash 40 at a coupling angle. In particular, the mounting bracket 252 can include a resilient member 253 configured to bias the second elongated arm 250 into the coupling angle. In certain embodiments, the coupling angle of the second elongated arm 250 may aid in coupling the first and second arm restrictors 220, 240, as will be described in greater detail below. In other embodiments, when the second arm restrictor 240 is mounted to a vertical surface of the window sash 40, the mounting bracket 252 can include a stopper (not shown) configured to retain the second elongated arm 250 at the coupling angle when the first and second arm restrictors 220, 240 are uncoupled.

In addition to the mounting bracket 252 to which the second elongated arm 250 is pivotally mounted, the second arm restrictor 240 includes a sliding member 262 slidingly mounted to the second elongated arm 250 via a pin-slot mechanism (shown in FIG. 19), defining a sliding axis A extending substantially parallel to a longitudinal axis of the second elongated arm 250. It will be understood that, in other embodiments, the sliding member 262 can be mounted to the second elongated arm 250 using any other suitable sliding mechanism. In certain embodiments, the sliding member 262 includes an elongated body 263 extending substantially parallel to and superposing the second elongated arm 250 so as to define a proximal section 268 including a proximal end and a distal section 264 including a distal end. The distal section 264 of the sliding member 262 is biased towards the distal end of the second elongated arm 250. To do so, in certain embodiments, the second arm restrictor 240 can include a biasing member 272, which in the non-limitative embodiment shown in FIG. 19 is a compression spring, mounted in a spring cavity 265 between the second elongated arm 250 and the sliding member 262 to bias the distal section 264 of the sliding member 262 towards the distal end of the second elongated arm 250. It is appreciated that the biasing member 272 can vary from the embodiment shown. For instance and without being limitative, a tension spring can be used. In the embodiment shown, the release/retention mechanism 260 is mounted to the second arm restrictor 240. However, it is appreciated that, in an alternative embodiment (not shown), the release/retention mechanism 260 can be mounted to the first arm restrictor 220.

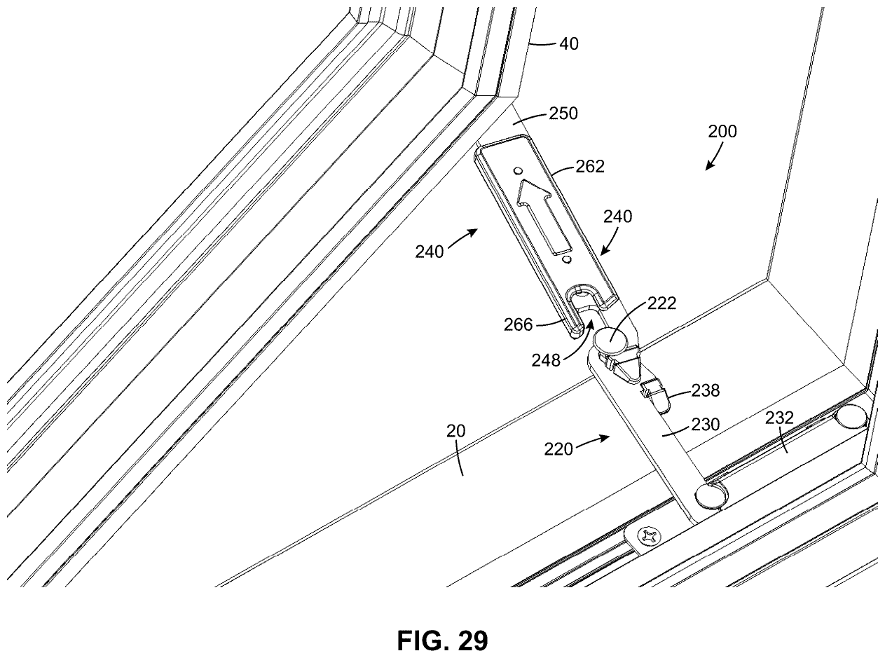

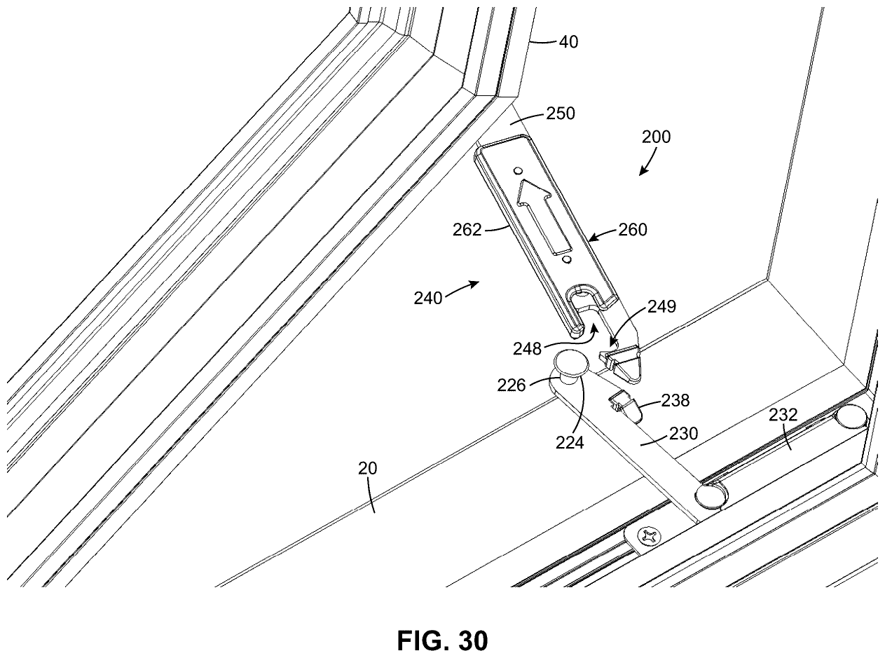

A combination of the sliding member 262 and the biasing member 272 defines a retention mechanism to ensure that the first and second connectors 222, 242 remain coupled together and a release mechanism 260 to uncouple the first and second connectors 222, 242, as will be described in more details below. More specifically, the sliding member 262 is selectively configurable in a release configuration (FIGS. 29 to 30) when a force is applied onto the sliding member 262 along the sliding axis A to compress the biasing member 272 and translate the sliding member 262 towards the proximal section 268 of the second elongated arm 250, and a locked configuration (FIGS. 20 to 24) wherein the distal portion 264 of the sliding member 262 is biased towards the distal end of the second elongated arm 250.

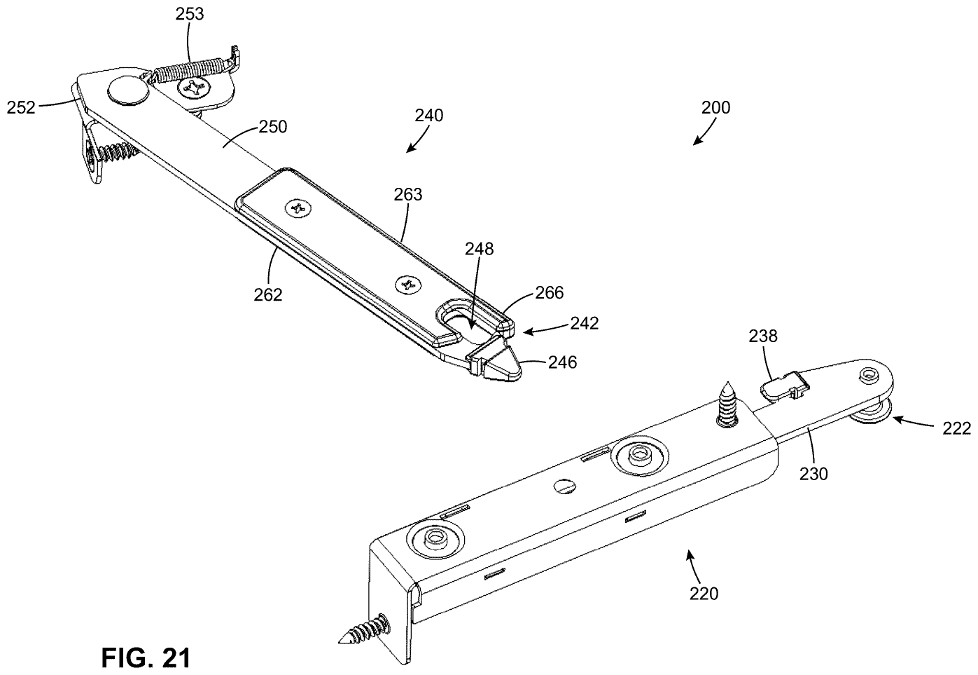

In the non-limitative embodiment shown, the second connector 242 is a locking aperture 248 defined in part by the second elongated arm 250 and the sliding member 262. In particular, the locking aperture 248 extends through the second elongated arm 250 with a lateral side thereof being delimited by the sliding member 262 when in the locked configuration. Referring to FIGS. 20 and 21, in certain embodiments, the sliding member 262 includes a projection 266 extending along the longitudinal axis of the elongated body 263 to delimit the locking aperture 248 when the sliding member 262 is in the locked configuration. The locking aperture 248 can thus retain the locking member 226 when delimited by the projection 266 and be accessible from an open lateral side of the second elongated arm 250 when the sliding member 262 is in the released configuration, as will be described in greater detail below.

In the coupled configuration of the first and second connectors 222, 242, the locking member 222 is insertable in the locking aperture 248. Accordingly, the locking aperture 248 is sized and shaped to receive the locking member 248 therein. In the non-limitative embodiment shown, the locking aperture 248 has an oblong shape. It is appreciated that the nature, the size, the shape, and the configuration of the second connector 242 can however vary from the embodiment shown.

In some embodiments, the head portion 224 of the male connector 222 can have a cross-sectional area being larger than a cross-sectional area of the locking aperture 248 to prevent a transverse displacement between the first and second connectors 222, 242 when in the coupled configuration. In such embodiments, the head gap is about equal or greater than a depth of the locking aperture 248 (i.e., a thickness of the second elongated arm 250 and the sliding mechanism 262 around the locking aperture 248). Thus, the first connector 222 is insertable into the locking aperture 248 through a lateral side thereof and configurable in a manner such that the first and second arm connectors 220, 240 remain connected while enabling them to pivot relative to one another.

In the non-limitative embodiment shown, the second arm restrictor 240 includes a pointed distal tip 246 at a distal end of the second elongated arm 250 to aid in coupling the first and second arm restrictors 220, 240, as will be described in greater detail below. In certain embodiments, the distal tip 246 can be manufactured in accordance with any known method using any suitable material including, for instance, plastic, wood, vinyl, fiberglass and/or aluminum. In certain embodiments, the distal tip 246 can be unitary with the second elongated arm 250.

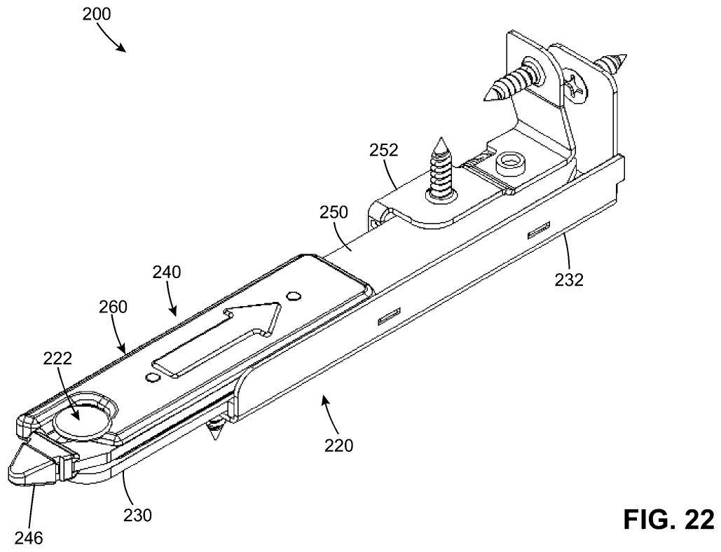

Similar to the window opening control device 100 described above, when the window assembly 10 is configured in the closed configuration, the first and the second arm restrictors 220, 240 of the window opening control device 200 are superposed in a compacted configuration (as shown in FIG. 22) and the first and second connectors 222, 242 are automatically coupled together.

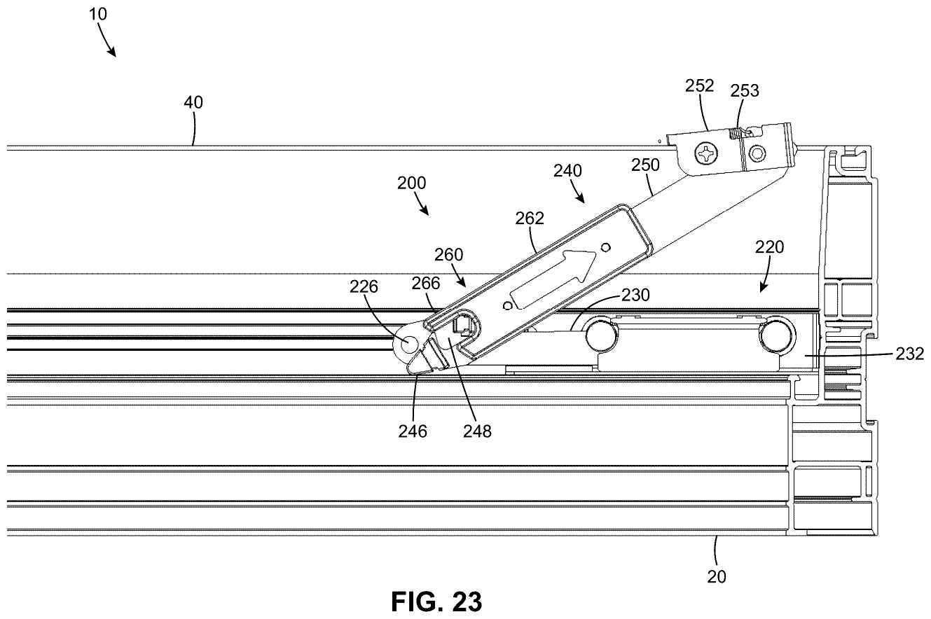

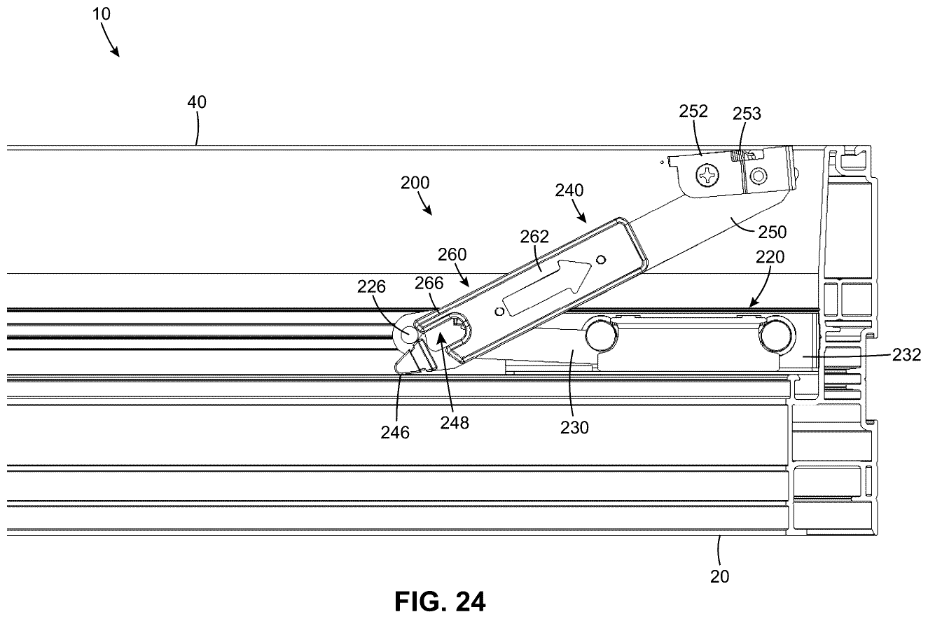

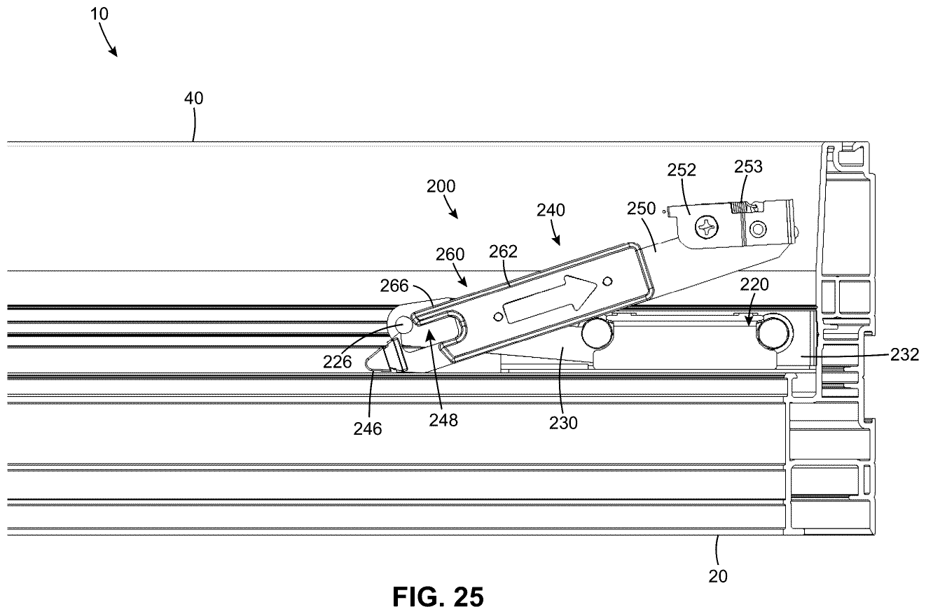

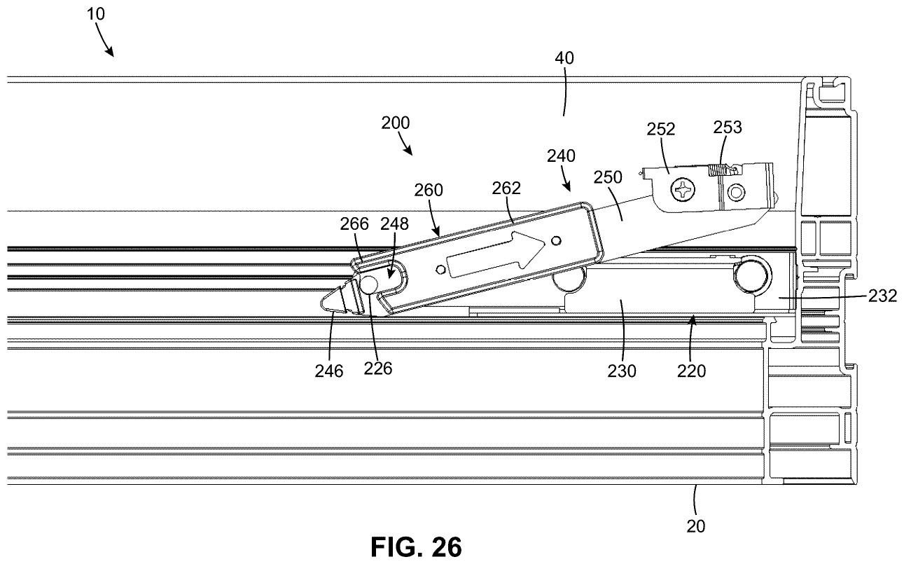

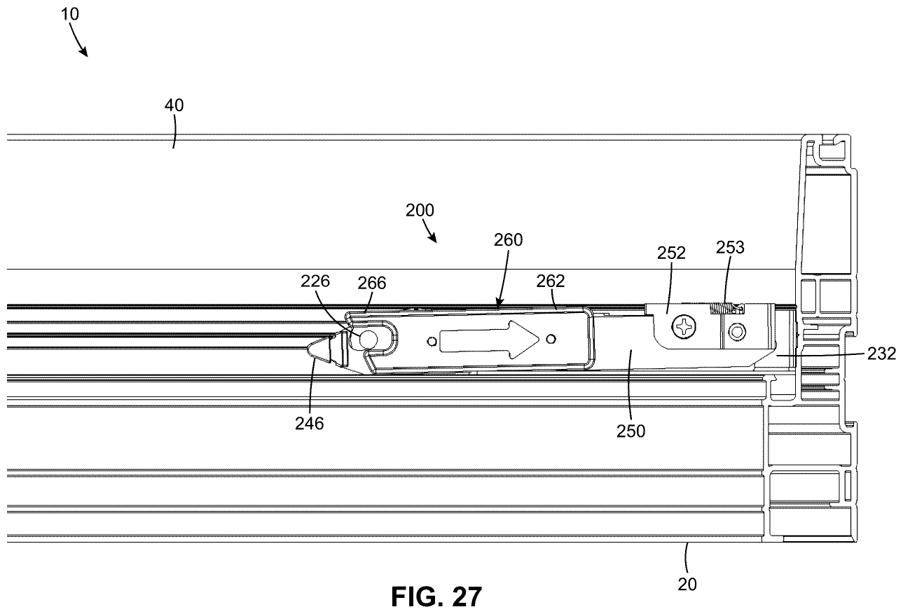

Referring now to FIGS. 23 to 27, a coupling of the first and second connectors 222, 242 is shown. As stated above, in certain embodiments, the first elongated arm 230 can be configured to pivot towards the window frame 20 and is superposed thereto when in a rest position (i.e., when the first and second arm connectors 220, 240 are uncoupled with no external force being applied to the first elongated arm 230). Moreover, the second elongated arm 250 can be configured to pivot towards a coupling angle when in a rest position to position the second arm connector 240 in a coupling alignment with the first arm connector 220 as the window sash 40 is pivoted towards the closed position. It will be understood that, in the present description, the expression “coupling alignment” is intended to refer to an alignment of the first and second arm connectors 220, 240 suitable for coupling as the window sash 40 is pivoted towards the closed position. As shown in FIG. 23, when at the coupling angle, the elongated arm 250 defines a non-zero degree angle with respect to a longitudinal axis of the window sash 40 to position the distal tip 246 within a gap formed between the locking member 226 of the first arm restrictor 220 and the frame of the window frame 20. Positioned in this manner, the second arm restrictor 240 can slide alongside the first arm restrictor 220 as the window sash 40 is pivoted into the closed position to align the projection 266 of the sliding member 262 with the locking member 226, as shown in FIGS. 24 and 25. Configured in this manner, the locking member 226 is positioned to contact a distal edge of the projection 266 of the sliding member 262 so as to impel the sliding member 262 into the release configuration as the window sash 40 is further pivoted into the closed position. Referring now to FIGS. 26 and 27, in a final stage of the coupling of the first and second arm restrictors 220, 240, the second arm restrictor 240 is pivoted to superpose the first arm restrictor 220 in the compacted configuration thereby positioning the locking member 226 into the locking aperture 248. The sliding member 262, no longer impelled by the locking member 226, thus slides into the locked configuration to retain the locking member 226 in the locking aperture 248, and the first and second arm connectors 220, 240 are thus coupled.

In the non-limitative embodiment shown, the first arm restrictor 220 includes a deflector plate 235 mounted to the first elongated arm 230 and configured to conceal the resilient member 233 when the first arm restrictor 220 is assembled. The deflector plate 235 can further prevent an interaction between the distal tip 246 of the elongated arm 250 and the resilient member 233 during the coupling of the first and second arm connectors 220, 240 described above.

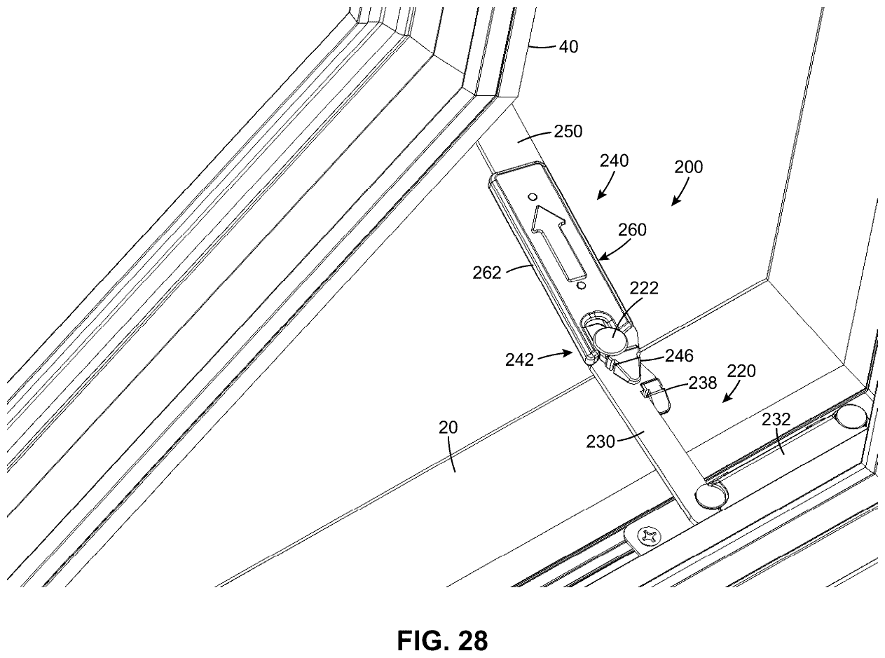

To further open the window assembly 10 past the maximal opening, the first and second connectors 222, 242 must be manually disengaged from one another as shown in FIGS. 28 to 31. As stated above, the first and second connectors 222, 242 can be manually disengaged by translating the sliding mechanism 262 towards the proximal end of the second elongated arm 250 thereby transitioning the release mechanism 260 into the released configuration. When in the released configuration, the locking member 226 can be released from the locking aperture 248 through the open lateral side (previously delimited by the projection 266 of the sliding mechanism 262 in the locked configuration) by pivoting one or both of the first and second arm restrictors 220, 240 away from each other.

In certain embodiments, a distal inner peripheral edge delimitating the locking aperture 248 can extend toward a proximal end of the second elongated arm 250 along a curved path to define a concave channel 249 sized to receive the locking member 226 when the first and second arm restrictors 220, 240 are under tension in the extended configuration. In such embodiments, the concave channel 249 can restrict a release of the locking member 226 from the locking aperture 248 when the first and second arm restrictors 220, 240 are in tension. In such embodiments, the window opening control device 200 may require two distinct manual operations to decouple the first and second arm restrictors 220, 240. In particular, in the illustrated embodiment, the window opening control device 200 requires a transition of the release mechanism 260 from the locked configuration to the release configuration, followed by a detensioning of the first and second arm restrictors 220, 240 to position the locking member 226 out of the concave channel 249 so as to allow its release from the locking aperture 248. It will be appreciated that requiring two separate manual operations to decouple the first and second arm restrictors 220, 240 may improve the security of the window opening control device 200 by preventing an accidental or undesired decoupling thereof.

As mentioned above, the first arm restrictor 220 can include a resilient member 233 configured to bias the first elongated arm 230 into the rest position, and the second arm restrictor 240 can include a resilient member 253 configured to bias the second elongated arm 250 into the coupling angle. It will be appreciated that, in such embodiments, the resilient members 233, 253 can bias the window opening control device 200 towards the collapsed configuration when pivoting the window sash 40 towards the closed position, thus preventing the opening control device 200 from pivoting past the extended configuration.

In certain embodiments, the window opening control device 200 can further include a pull tab (not shown) mounted to one of the second arm restrictor 240 and the window sash 40. The pull tab can be operated by a user to pull one of the second arm restrictor 240 and the window sash 40 towards the window frame 20 so as to reduce a tensioning of the first and second arm restrictors 220, 240 and to position the locking member 226 out of the concave channel 249. The pull tab can include any structure sized to be grasped by a user during operation of the window opening control device 200.

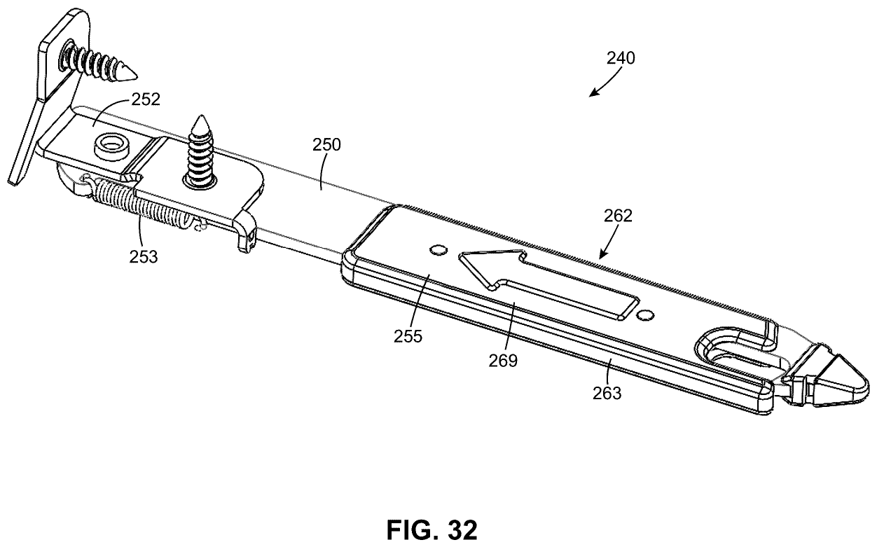

Referring now to FIG. 32, an embodiment of the second arm restrictor 240 is shown in which the second elongated arm 250 and the sliding member 262 include respective connectors configured to interlock when the release mechanism 260 is in the release configuration and to retain the release mechanism 260 in the release configuration while a force is applied in a distal direction of the second arm restrictor 240. In the non-limitative embodiment shown, the second elongated arm 250 defines a depression 255 and the sliding member 262 defines a protrusion 269 projecting from an inner surface of the elongated body 263 and sized to be received within the depression 255. In such embodiments, the sliding member 262 may be made of a semi-rigid material that allows the sliding member 262 to flex when subjected to a compressive force. Accordingly, when the release mechanism 260 is in the release configuration, the sliding member 262 can be subjected to a compressive force to insert the protrusion 269 of the sliding member 262 into the depression 255 of the second elongated arm 250 thereby interlocking the second elongated arm 250 and the sliding member 262 (i.e., preventing a translation of the sliding member 262 relative to the second elongated arm 250). It will be appreciated that, configured in this manner, the sliding member 262 can be compressed while the release mechanism 260 is in the release configuration, for instance when the sliding member 262 is grasped by a user during operation of the window opening control device 200, to interlock the second elongated arm 250 and the sliding member 262 thereby enabling the user to pull the second arm restrictor 240 towards the window frame 20 so as to reduce a tensioning of the first and second arm restrictors 220, 240 and to position the locking member 226 out of the concave channel 249.

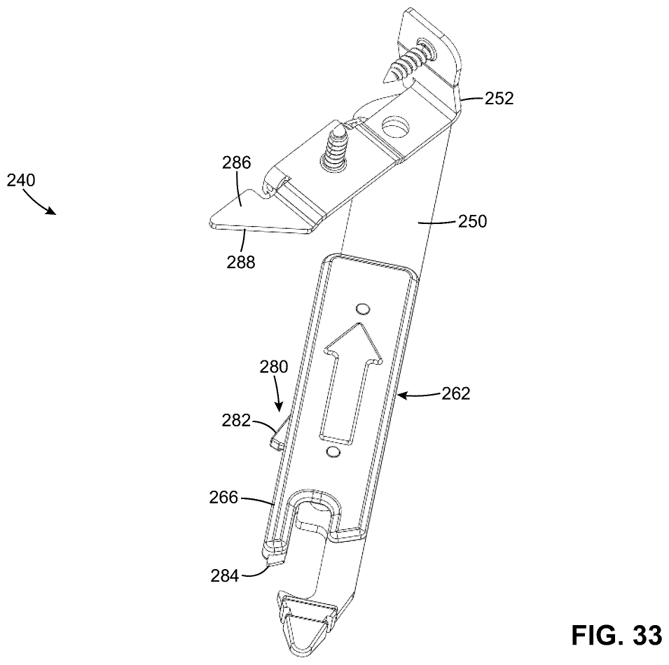

Referring now to FIGS. 33 to 37, an embodiment of the second arm restrictor 240 is shown in which the release mechanism 260 does not include a compression spring, mounted in a spring cavity 265 between the second elongated arm 250 and the sliding member 262 to bias the distal section 264 of the sliding member 262 towards the distal end of the second elongated arm 250. Instead, the release mechanism 260 includes a latch 280 configured to engage a notch (not shown) defined in the second elongated arm 250 when the release mechanism 260 is in the locked configuration. Accordingly, in such embodiments, the sliding member 262 is configured to slide freely along the sliding axis A until the latch 280 engages the notch defined in the second elongated arm 250 to configure the release mechanism 260 in the locked configuration and thus limit a translation of the sliding member 262. In certain embodiments, the latch 280 includes a release member 282 projecting outwardly from the release mechanism 260 and configured to be operated by the user to disengage the latch 280 and the notch and to once again enable a translation of the sliding member 262 along the sliding axis A.

In certain embodiments, the release mechanism 260 can further include a release pin 284 extending from the distal edge of the projection 266 and configured to disengage the latch 280 and the notch similarly to the release member 282. More specifically, the release pin 284 can be slidingly mounted within the sliding member 262 and positioned to contact the locking member 226 during a coupling of the first and second connectors 222, 242, as will be described in greater detail below. It will be appreciated that it is necessary for the release mechanism 260 to be in the released configuration during a coupling of the first and second connectors 222, 242. The release pin 284 may thus enable the release mechanism 260 to be released from the locked configuration during coupling of the first and second connectors 222, 242 if the release mechanism 260 is in the locked configuration.

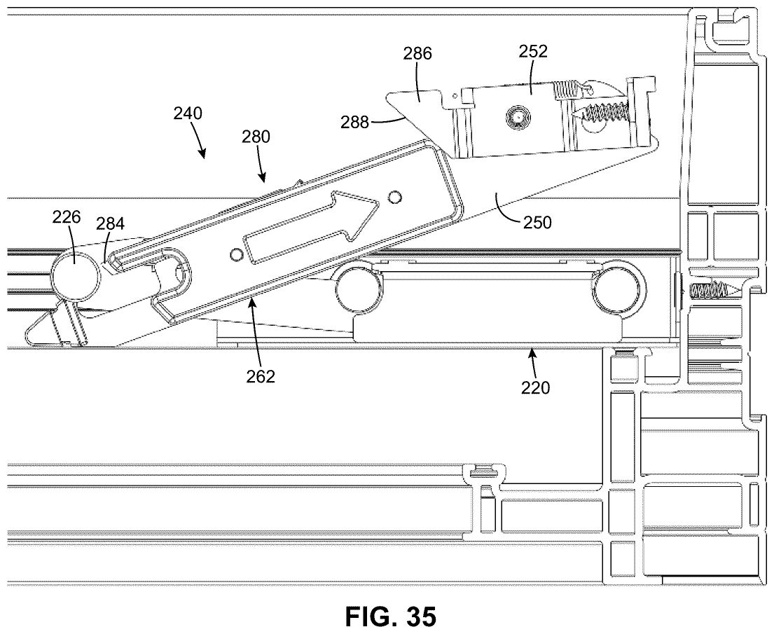

Referring now to FIGS. 35 to 37, a coupling of the first and second connectors 222, 242 is shown while the release mechanism 260 is in a locked configuration. As stated above, the second elongated arm 250 can be configured to pivot towards a coupling angle when in a rest position to position the second arm connector 240 in a coupling alignment with the first arm connector 220 as the window sash 40 is pivoted towards the closed position. As shown in FIG. 35, when at the coupling angle, the distal tip 246 of the second arm restrictor 240 is positioned within a gap formed between the locking member 226 of the first arm restrictor 220 and the frame of the window frame 20 as the window sash 40 is pivoted towards a closed position. Positioned in this manner, the second arm restrictor 240 can slide alongside the first arm restrictor 220 as the window sash 40 is pivoted into the closed position to align the release pin 284 of the latch 280 with the locking member 226, as shown in FIG. 35. Configured in this manner, the locking member 226 is positioned to engage the release pin 284 of the release latch 280 so as to release the release mechanism 260 as the window sash 40 is further pivoted into the closed position.

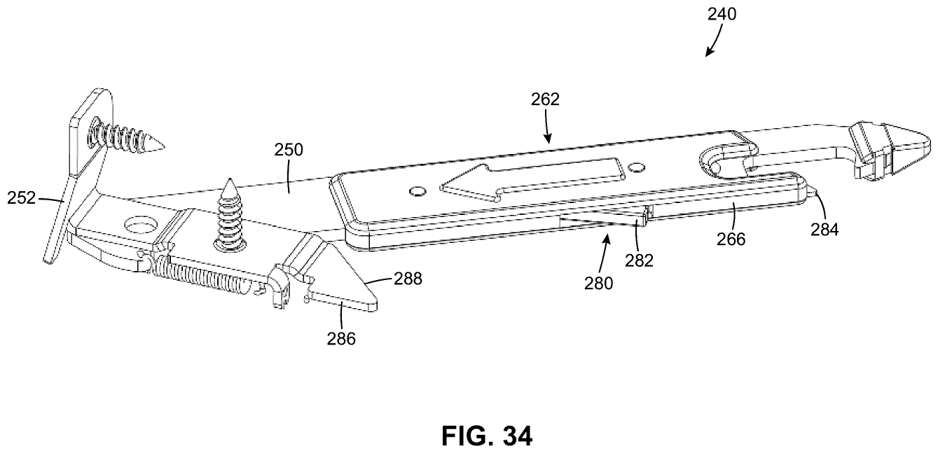

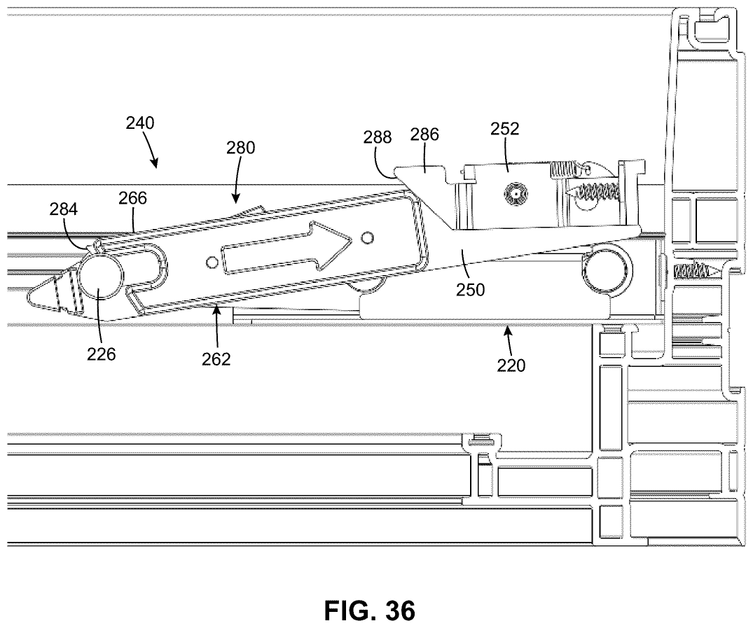

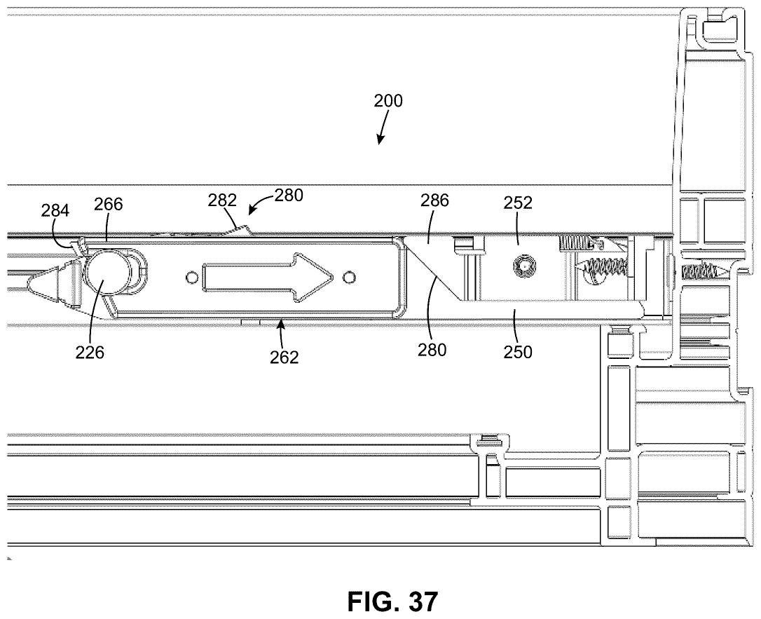

Referring back to FIGS. 33 and 34, in certain embodiments, the mounting bracket 252 can include a biasing arm 286 projecting along a plane being substantially normal to the axis of rotation X₄-X₄ of the second elongated arm 250. The biasing arm 286 can be sized and shaped to engage the sliding member 262 as the window sash 40 is pivoted into the closed position so as to bias the release mechanism 260 into the locked configuration. In the embodiment shown, the biasing arm 286 defines a tapered edge 288 having a first end positioned to engage the sliding member 262 following an engagement between the release pin 284 and the locking member 226 as the window sash 40 is pivoted into the closed position. Referring now to FIGS. 36 and 37, in a final stage of the coupling of the first and second arm restrictors 220, 240, the second arm restrictor 240 is pivoted to superpose the first arm restrictor 220 in the compacted configuration thereby positioning the locking member 226 into the locking aperture 248. The tapered edge 288 of the biasing arm 286 impels the sliding member 226 towards the distal end of the second arm restrictor 240 to align the latch 280 with the notch and thus transition the release mechanism into the locked configuration.

In the embodiment shown in FIGS. 17 to 20, each of the mounting brackets 232, 252 includes a first planar portion 232a, 252a onto which the first and second elongated arms 230, 250 are mounted, respectively. In certain embodiments, the mounting brackets 232, 252 can further include a second planar portion 232b, 252b extending substantially orthogonally from an end of the first planar portion 232a, 252a, respectively, to define a corner bracket. Configured in this manner, the mounting brackets 232, 252 can be secured at respective corners of the window frame 20 and the window sash 40 thereby aiding in an alignment of the first and second connectors 222, 232 during the coupling of the first and second arm restrictors 220, 224, as described above.

In the above description, an embodiment is an example or implementation of the inventions. The various appearances of “one embodiment,” “an embodiment” or “some embodiments” do not necessarily all refer to the same embodiments. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not be construed that there is only one of that element.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A window opening control device, comprising:
a first restrictor arm having a proximal end pivotably securable to one of a window frame and a window sash and including a first connector;
a second restrictor arm having a proximal end pivotably securable to the other one of the window frame and the window sash and including second connector couplable with the first connector, the first and the second restrictor arms being configurable in a compacted configuration wherein they are superposed to one another and an extended configuration wherein they are connected by the first and second connectors being coupled together to limit a pivotal travel of the window sash with respect to the window frame; and
a release mechanism mounted to one of the first and second restrictor arms and actionable to disengage the first and the second connectors, the first and the second connectors being automatically coupled together in the compacted configuration.

2. The window opening control device of claim 1, wherein the first connector is a male connector, and the second connector is a female connector couplable with the male connector to provide a pivotable connector connection inbetween.

3. The window opening control device of claim 1, wherein the first restrictor arm comprises a first mounting bracket securable to the one of the window frame and the window sash, and a first elongated arm pivotally mounted to the first mounting bracket, the first elongated arm having the first connector provided thereon.

4. The window opening control device of claim 3, wherein the first restrictor arm comprises a resilient member configured to pivotally bias the first elongated arm towards the one of the window frame and the window sash wherein the first elongated arm superposes the one of the window frame and the window sash.

5. The window opening control device of claim 3, wherein the first restrictor arm comprises an abutment shaped to space-apart the first elongated arm from the one of the window frame and the window sash when the first elongated arm superposes the one of the window frame and the window sash.

6. The window opening control device of claim 3, wherein the second restrictor arm comprises a second mounting bracket securable to the other one of the window frame and the window sash, a second elongated arm pivotally mounted to the second mounting bracket and having the second connector provided thereon, and the release mechanism mounted to the second elongated arm.

7. The window opening control device of claim 6, wherein the second arm restrictor comprises a resilient member configured to pivotally bias the second elongated arm into a coupling angle wherein the second connector of the second arm restrictor is in a coupling alignment with the first connector of the first arm restrictor when the first and second arm restrictors are uncoupled.

8. The window opening control device of claim 6, wherein at least one of the first and second mounting brackets is a corner bracket securable to a corner portion of the respective one of the window frame and the window sash to align the first and second restrictor arms when in the compacted configuration.

9. The window opening control device of claim 6, wherein the release mechanism comprises a sliding member movable between a release configuration and a locked configuration, and a biasing member biasing the sliding member towards the locked configuration.

10. The window opening control device of claim 6, wherein the second connector is a locking aperture extending through the second elongated arm and being at least partially delimited by the sliding member when the sliding member is in the locked configuration.

11. The window opening control device of claim 10, wherein the sliding member comprises a projection extending along a periphery of the locking aperture when the sliding member is in the locked configuration to at least partially delimit the locking aperture.

12. The window opening control device of claim 10, wherein the first connector is a locking member sized to be received within the locking aperture when the first and second connectors are coupled together.

13. The window opening control device of claim 12, wherein the first connector further comprises a head portion provided at a distal end of the locking member and spaced-apart from the first elongated arm to define a head gap sized to receive second elongated arm.

14. The window opening control device of claim 12, wherein the locking aperture defines a concave channel at a distal end thereof sized to receive the first connector therein when the first and second arm restrictors are tensioned in the extended configuration.

15. The window control device of claim 6, wherein the second elongated arm comprises a pointed distal tip sized for insertion between a gap formed between the first connector and the one of the window frame and the window sash when the first elongated arm is in a rest position.

16. A window assembly comprising:
a window frame;
a window sash pivotably mounted to the window frame; and
a window opening control device of claim 1.

17. A method of restricting a window opening, the method comprising:
securing a first arm restrictor to a window frame, the first arm restrictor comprising a first connector and being pivotally mounted to the window frame;
securing a second arm restrictor to a window sash, the second arm restrictor comprising a second connector and being pivotally mounted to the window sash;
pivotally biasing the first arm restrictor toward the window frame to superpose the window frame;
pivotally biasing the second arm restrictor to position the second connector of the second arm restrictor in a coupling alignment with the first connector of the first arm restrictor; and
pivoting the window sash in a closed configuration to automatically couple the first connector of the first arm restrictor with the second connector of the second arm restrictor and the first and second restrictor arms are superposed.

18. The method of claim 17, wherein coupling the first and second connectors comprises transitioning a release mechanism of one of the first and second connectors from a locked configuration to a release configuration to expose an open lateral side of a locking aperture of a corresponding one of the first and second connectors.

19. The method of claim 18, wherein transitioning the release mechanism from the locked configuration to the release configuration comprises sliding a sliding member along a longitudinal axis of the corresponding one of the first and second arm restrictors.

20. The method of claim 17, further comprising pivoting the window sash outwardly until the displacement of the window sash is constrained by the coupling of the first and second arm restrictors.
